(19) United States
(12) Patent Application Publication
(10) Pub. No.: US 2022/0371219 A1
(43) Pub. Date: Nov. 24, 2022

(54) THERMALLY MODIFIED COMPOSITE WOOD-STRAND PRODUCTS FOR CONSTRUCTION AND OTHER APPLICATIONS

(71) Applicants: Washington State University, Pullman, WA (US); UNIVERSITY OF MINNESOTA DULUTH, Duluth, MN (US)

(72) Inventors: Vikram YADAMA, Pullman, WA (US); Ruben A. JERVES, Pullman, WA (US); Matthew ARO, Duluth, MN (US)

(21) Appl. No.: 17/745,174

(22) Filed: May 16, 2022

Related U.S. Application Data
(60) Provisional application No. 63/191,184, filed on May 20, 2021.

(51) Int. Cl. B27D 1/04; B32B 21/14; B32B 21/13; B32B 37/12; B27N 3/04; B27N 1/00

(52) U.S. Cl. CPC B27D 1/04; B32B 21/14; B32B 21/13; B32B 37/12; B27N 3/04; B27N 1/00; B32B 2260/026; B32B 2309/025; B32B 2309/12

(57) ABSTRACT

Improved wood strand panels suitable for construction are produced by first thermally modifying a plurality of wood strands that are thin in terms of thickness. Then, wood veneers are constructed from the thermally modified wood strands, at least some of which partially overlap one another. The wood veneers are on the order of 0.125 to 0.25 inches thick. Finally, the wood veneers, constructed from the thermally modified wood strands, are stacked on top of one another and connected using adhesive, pressure and temperature similar to plywood or LVL manufacture. The thermal modification and use of thin strands, followed by veneer formation, prior to manufacture of the composite results in a composite with uniform density, high-strength, resistance to decay, resistance to water sorption, and other benefits.

### CROSS-REFERENCE TO RELATED APPLICATIONS

This application claims priority to U.S. patent application 63/191,184, filed May 20, 2021, the contents of which are herein incorporated by reference.

### STATEMENT OF FEDERALLY SPONSORED RESEARCH AND DEVELOPMENT

This invention was made with government support under grant number 1827434 awarded by the National Science Foundation. The government has certain rights in the invention.

### FIELD OF THE INVENTION

The invention generally relates to fabrication of wood-strand products, and particularly to thermal modification of strands. The processes of the invention, which include the formation of veneers from thermally modified strands, can be employed in a wide variety of product manufacture including without limitation strand-based timber panels, laminated veneer lumber, stand-based plywood, oriented strand board (OSB) like panels, etc.

### BACKGROUND OF THE INVENTION

Mass timber construction is rapidly growing in North America, mostly due to its versatility and performance. For instance, wood has a high strength-to-weight ratio and low environmental impact in contrast with other construction materials, with the added benefit that it is renewable and if managed adequately sustainable too. Mass timber construction offers fast construction times and ensures quality control since the elements are prefabricated. Overall, the benefits of using mass timber are vast; nevertheless, durability is a significant concern that needs to be addressed for the advancement of mass timber construction. Extreme care is required to protect members from exposure to high moisture environments while ensuring long-term durability. Furthermore, mass timber products are mostly fabricated with high-quality lumber, requiring long growing periods and strict quality assurance processes, adding to the cost of the end-product. On the other hand, small diameter timber (SDT), with fast-growing periods, is vastly available in North America and if used for mass timber it would provide economic benefits for the forest product industry, while providing ecological benefits and mitigating forest fires, which are a growing concern around the globe. Yet, the use of SDT comes at the expense of an even less durable material.

Thermal modification or “TM” is widely recognized by the wood community to provide two main benefits to wood: improved dimensional stability and resistance to decay. In recent years, there has been a growing interest in TM of wood to manufacture wood-based products and composites to improve their dimensional stability and decay resistance. However, the effects of TM are influenced by many variables, such as dwell time, autoclave/kiln temperature, presence of inert gases in the autoclave/kiln, pressure, wood species, and moisture conditions of the material. Therefore, it is critical to understand the impact of these variables to effectively apply TM to successfully scale up the process and commercialize thermally modified wood products.

For instance, Pelaez-Samaniego et al. [1] performed a review on thermal pretreatment of wood composites; summarizing some of the main findings to be improvements in dimensional stability, reduction of hygroscopicity, and gains in decay resistance. In general, however, TM has been found to degrade the mechanical performance of wood, although in some cases a slight increase in stiffness has been reported [2, 3 , 4, 5]. Similar findings on the effects of TM of lumber have been found elsewhere [6, 7], emphasizing the improved resistance to decaying organisms and moisture. Through several studies, researchers have analyzed and highlighted why TM offers such changes to wood. Shafizadeh and Chin [8] commented that hemicellulose is more easily degraded than other wood components during thermal treatment. Hillis [9] noted that hemicellulose provides hygroscopicity to wood, and further added that TM wood under moist environments could lead to higher dimensional stability. Likewise, Hosseinaei [10] mentioned that hemicellulose is highly hydrophilic, and thus its extraction may be desired for the decrease of water absorption. Hill [11] mentioned that when wood is heated to 140° C. or more, it undergoes a dehydration process, where OH groups, which attract moisture, are progressively lost as temperature increases. Mitchell [12], as referred by Hill [11], observed that the use of moist environments during TM accelerates the formation of organic acids, which catalyzes the hydrolysis of hemicellulose and also, but to a lesser extent, amorphous cellulose. From which, Capri et al. [13] recalled that amorphous cellulose attracts more water than crystalline cellulose because it is abundant with free hydroxyl groups that attract water molecules (OH groups). Ding [14] also noted that pressurized steam further accelerates the degradation of amorphous cellulose. On the other hand, decay resistance is expected to be improved due to the degradation of polysaccharides, which serves as an alimentary source for wood-rotting fungi, as well as other possible changes in the chemical composition of the treated wood as mentioned by different researchers [15, 16]. Another prospective cause of the improved decay resistance, as stated by Hill [11], is linked to the reduced moisture content of the cell wall. Also, it is thought that the loss of OH groups may affect the ability of enzymes to metabolize the wood substrate.

### SUMMARY

In an embodiment of the invention, wood strands are first thermally modified, then wood veneers are constructed from a plurality of the thermally modified wood strands, and then composite panels for construction are manufactured from a plurality of the wood veneers.

Investigations of thermal modification effects on wood strands and subsequent wood-strand composite panels under a pressurized system, namely a hygrothermal treatment, and the out-of-plane bending performance of cross-laminated strand veneer lumber (CLSVL) made of thermally modified (TM) strands, demonstrated, that with proper sizing of strands, consolidation of thermally modified strands under heat and pressure densification by thermal treatment of strands, and production of veneers of the strands, allowed for the production of composite materials with desirable properties, including reduced moisture sorption and water wettability and improved fungal decay resistance. Flexural properties of the composites were also evaluated. The determined properties were used in the Shear Analogy Method (SAM) and a Timoshenko Beam Element (TBE) formulation to predict the flexural behavior of 15-ply CLSVL under different loading conditions and span-to-depth ratios. The comprehensive study of the TM composite revealed improved moisture and decay resistance with some affects on in mechanical properties; nevertheless, these properties were comparable to other structural grade wood and wood composites. The SAM in conjunction with the TBE effectively predicted the flexural behavior of the CLSVL. This altogether is able to create a predictable wood-strand composite with an increased service life expectancy, further advancing the material properties of rapidly growing wood and wood-derived materials.

In embodiments of the invention, wood strands that are 3 to 8 inches long, 0.25 to 2.5 inches wide, and 0.012 to 0.020 inches thick are thermally modified, e.g., in autoclave or kiln. Thin strand-based veneers that are 0.125-0.25″ thick are then constructed from a plurality of the thermally modified strands. All strands are oriented in general parallel to the length or in the machine direction. With respect to the machine direction, in general, strands are oriented + or −35 deg. Therefore, each veneer is a unidirectional strand composite panel. A thicker, balanced (i.e., symmetrical with respect to the mid-plane), composite panel made with these unidirectional strand composite panels can be engineered with veneers oriented in long direction or orthogonal to it or in any other angle in between 0 and 90 deg. The strand veneers are uniform in density through the thickness. Strand-based laminates can be fabricated that are, for example, ⅜″ thick to whatever thickness required for an application (even as thick as 12″ to 24″). With the processes of this invention, it is possible to make lumber dimensions with strand veneers and then make mass timber panels using these strand-based lumber. Even the thick composite panels will have uniform density through the thickness because each strand veneer's density is uniform through the thickness.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 is a graphical abstract of the inventive process and shows by example production of durable mass timber products from SDT.

FIG. 2 is a graph showing exemplary thermal modification parameters at 165° C. and 180 min dwell time.

FIGS. 3a-c show wood strands before thermal modification in panel a, after thermal modification in panel b, and a comparison for three separate heat treatments as compared to control.

FIGS. 4a-b illustrate the tensile stress set up used in the investigations.

FIGS. 5a-c illustrate measurement of the surface free energy (SFE) by the sessile drop method.

FIG. 6 is a schematic illustration of wetting through spreading and penetration.

FIGS. 7a-b show examples of powder samples and x-ray diffraction (XRD) samples used in the Example below.

FIGS. 8a-b are graphs illustrating the TM effect on tensile properties of wood strands where (a) and (b) show the temperature effect with a dwell time of 180 minutes (groups with the same letter are not significantly different (p<0.5)).

FIGS. 9a-b are graphs illustrating the thermal modification effect on tensile properties of wood strands where (a) and (b) show the temperature effect at 165° C. (groups with the same letter are not significantly different (p<0.5)).

FIG. 10 is a bar graph showing a comparison of the temperature effect, at different temperatures, on the degree of crystallinity (CrI(%)) at 180 min dwell time.

FIG. 11 is a bar graph showing the temperature effects on wettability at 180 min dwell time; surface free energy (SFE) and pMDI resin dynamic wettability (K-value is from the Shri-Gardner model).

FIG. 12 presents graphs showing the wetting envelope for different liquids both measured and expected at differing temperatures.

FIG. 13 presents graphs illustrating structural carbohydrate and lignin content changes for different temperatures at 180 min dwell time.

FIG. 14 presents graphs showing the moisture isotherm at 22±1° C. that illustrate the temperature effect at 180 min dwell time at different temperatures.

FIG. 15 presents graphs showing the moisture isotherm at 22±1° C. that illustrate the temperature effect at 165° C. for different dwell times.

FIG. 16 is a graph illustrating the weight loss from a fungal decay test for wood strands. Groups with the same letter are not significantly different (p<0.05).

FIG. 17 is a graph illustrating the weight loss from a decay test for wood-strand composite panels. Groups with the same letter are not significantly different (p<0.05).

FIG. 18 is an example of a pressing schedule for an 89 cm×89 cm press with 6.4 mm thick panels.

FIG. 19 is a schematic showing the panel specimens used in the testing presented in the Example.

FIG. 20 is graph showing the determination of out-of-plane shear modulus by means of a variable span bending test.

FIG. 21 is an example of a typical vertical density profile of panels made using the inventive process.

FIGS. 22a-b are graphs showing, respectively, the mean vertical density profile and profile variation for various heat treatments and treatment times.

FIG. 23 are graphs showing the modulus of elasticity (MOE) parallel to the grain, highlighting the effects of thermal modification in three-point bending properties. Groups with the same letter are not significantly different (p<0.05).

FIG. 24 are graphs showing the modulus of rupture (MOR) parallel to the grain, highlighting the effects of thermal modification in three-point bending properties. Groups with the same letter are not significantly different (p<0.05).

FIGS. 25a-b are graphs showing, respectively, the shear free orthogonal modulus of elasticity (MOE₂) and shear modulus (G₂₃), highlighting the effects of thermal modification in three-point bending properties. Groups with the same letter are not significantly different (p<0.05).

FIG. 26 is a graph showing the thermal effect on internal bond (IB) strength of wood strand composite panels. Groups with the same letter are not significantly different (p<0.05).

FIGS. 27a-b are graphs which respectively show the water absorption (WA) and thickness swelling (TS) after twenty four hours of water submersion of different thermal modification intensities, and the ratio of WS to TS. Groups with the same letter are not significantly different (p<0.05).

FIG. 28 is a graph showing the weight loss from a fungal decay test on 381 mm×381 mm press panel specimens.

FIG. 29 is a table of benchmark values for static bending for a variety of wood materials, including the MOE, MOR, IB, WA, and TS.

FIG. 30 is a radar graph chart showing mechanical and durability performance of thermally modified panels at different treatment temperatures.

FIG. 31 is a set up for a four-point bending test (see schematic in FIG. 37a) with mid-span deflection using a string pot.

FIG. 32 is a setup for a three-point bending test (see schematic in FIG. 37b) with mid-span deflection recorded with a linear variable differential transformer (LVDT).

FIG. 33 is a graph of a typical pressing schedule for 137 cm×264 cm×7.6 mm thick panels.

FIG. 34 is a photograph of finished laminates prior to cold pressing.

FIG. 35 is a photograph showing the application of polyurethane (PUR) resin between wood strand composite laminates.

FIG. 36 is a schematic diagram providing the definition of local coordinates on wood strand composite panels.

FIGS. 37a-b schematically illustrate the set up for the four-point (a) and three-point (b) out-of-plane bending test.

FIGS. 38a-b are graphs showing theoretical distribution after out-of-plane bending across the cross section of a CLSVL element (e.g., an exemplary wood-strand based component produced as described herein).

FIGS. 39a-b are graphs showing the mid-span deflection of four-point bending test and model predictions.

FIGS. 40a-b are graphs showing the mid-span deflection of three-point bending tests and model predictions. It shows that TBT/SAM:Timoshenko Beam Theory in conjunction with the Shear Analogy Method accounts for shear deflection; BBT/SAM: Euler-Bernoulli Beam Theory in conjunction with the SAM does not account for shear deflection.

FIG. 41 shows the bending result after a four-point bending test with control.

FIG. 42 shows the bending result after a four-point bending test with TM composite wood panel according to an embodiment of the invention.

FIGS. 43a-b, respectively, show the control and TM composite wood panels prior to the bending test demonstrated in FIGS. 41 and 42.

### DETAILED DESCRIPTION

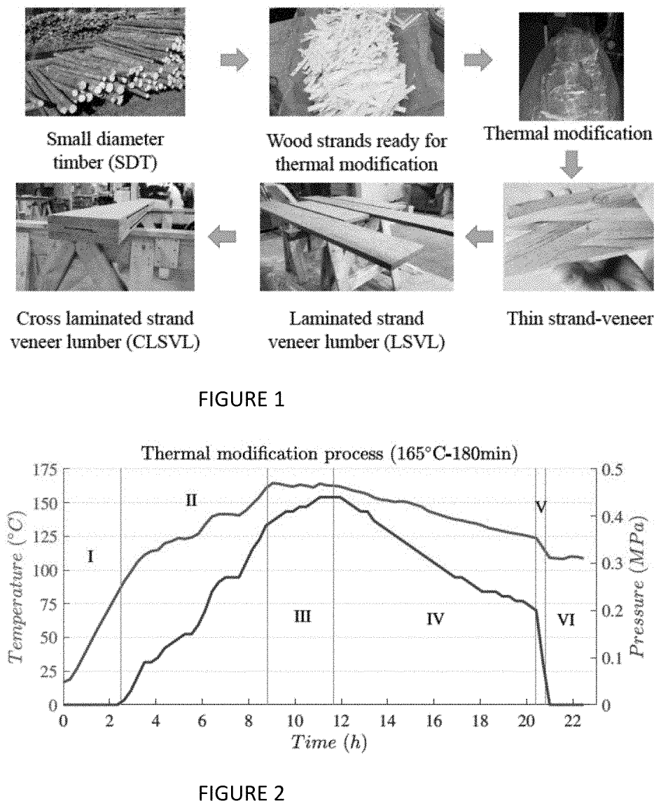

FIG. 1 presents a graphical abstract of an embodiment of the inventive process and products whereby softwood, and particularly less expensive and more abundant small diameter timber (SDT), is handled in a way which can result in durable mass timber products. However, it should be understood that the techniques of this invention can be employed with strands of softwood or strands of hardwood or mixtures of softwood and hardwood. Further, the processes can be used to make products of a single type of softwood, a plurality of different softwoods, a single type of hardwood, or a plurality of different types of hardwoods, or products that are mixtures of one or more softwoods with one or more hardwoods. Furthermore, the processes can be used to make a wide variety of products, not just mass timber panels. Rather, the processes can be used to produce thinner panels similar to (but characteristically different from) OSB. The final thickness and properties of the composite wood-strand products produced will depend on their intended use. That is, the thin, more durable and dimensionally stable, strand veneers constructed from thermally modified strands, can be used to make laminated veneer lumber, strand based plywood so to speak, and OSB like panels, as well as strand based mass timber panels, strand-based siding and flooring products. By bonding thin strand veneers together in desired configurations it is possible to makes LVL, OSL, plywood, lumber like products, glulam, and mass timber panels.

While it is known that TM leads to more brittle material, which is not desirable for structural applications, one of the benefits of the technology described herein is that it can recoup some of the loss of strength of TM strands by using the laminated veneer system. In the processes, a pressurized autoclave or a kiln may be used to modify the wood strands. The panels themselves may be produced using a hydraulic press or similar equipment. The products produced have a uniform density, as they are constructed from thin veneers, which are themselves constructed from thin TM strands.

With reference to FIG. 1, small diameter softwoods may be used in the practice of the invention. By small diameter, we mean trees having a diameter ranging from 3 to 6 inches. While larger diameter trees and hardwoods may also be used in the practice of the invention, one of the features of the invention is to be able to utilize plentiful and inexpensive lumber from SDT. By softwood we mean lumber cut from a coniferous or evergreen tree such as pine, spruce, and cedar. In some embodiments, other types of lumber may also be used in the practice of the invention. For example, hardwoods such as aspen, birch, balsa, and maple may also be employed in various embodiments of the invention.

The wood is cut into wood strands. In the practice of the invention, the wood strands are thermally modified with the goal of producing thermally modified wood strands that are 3 to 8 inches long (e.g., 4 to 6 inches long), 0.25 to 2.5 inches wide, and 0.012 to 0.020 inches thick. Thermal modification occurs well above ambient temperature, with good results being achieved at temperatures of 150° C. to 180° C. under pressure in an autoclave. In some applications the preferred temperature may range from 165° C. to 175° . At ambient pressure in a kiln thermal modification may take place at temperatures ranging from 150-240° C. As will be discussed below, the thermal treatment may be achieved with a thermal ramp up, hold, and ramp down cycle, with dwell times at the desired temperature of 0.5 to 2.5 hrs and the complete cycle taking 5-10 hrs. Crystallinity within the wood strand increases slightly from the thermal modification relative to an untreated wood strand. The thermal modification should be performed such that the thermally modified wood strand retains at least 70% of its strength relative to wood strands that are not treated (e.g., no more than a 20-25% reduction in strength is preferred). The reduction in strength is due largely to the degradation of hemicelluloses due to heating. However, while there is some loss in strength (but not so great as to reduce it by more than 20-30%), the thermally treated wood strand becomes more resistant to decay and moisture.

As shown in FIG. 1, wood veneers are made from the thermally modified wood strands. These wood veneers are made by combining a plurality of thermally modified wood strands with adhesive and then treating the combination with heat and pressure to make a thin flat veneer that is 0.125 to 0.250 inches thick. The veneers have at least some of the thermally modified strands stacked on top of one another in a partially overlapping fashion. As shown in FIG. 1, the veneers are wider, and can be longer, than the thermally modified strands. This is because some of the strands overlap portions of other strands and extend beyond the length and width dimensions of the neighboring strands. The overlapping strands can be in the same direction, perpendicular directions, and at any angle in between. Because multiple thermally modified strands are used to make a single veneer, the veneers are relatively thicker than a single strand. However, the thickness of the veneer is relatively thin (e.g., 0.125 to 0.25 inches as noted above). Because multiple thermally modified strands are used, and those strands are relatively thin to begin with, the density of the veneers is fairly uniform and ranges between 15 to 50 lbs per cubic foot. Some applications benefit from the veneers having a density of 20 to 50 lbs per cubic foot or 30 to 50 lbs per cubic foot. The density is dependent on the wood which is used (i.e., balsa wood is less dense than fir and pine), and on the adhesive used.

A variety of resins can be used as adhesives to manufacture the veneers. Good results have been obtained with polymeric diphenylmethane diisocyanate (pMDI) adhesives. However other resins such as phenyl formaldehyde (PF), urea formaldehyde (UF), melamine urea formaldehyde (MUF), or any adhesives commonly used in OSB production should be suitable. The veneers can be mad by using a press (preferably hydraulic) to squeeze the TM strands and adhesive together. Temperatures of 150° to 180° C. can be used.

Polyurethanes (PURs) and other adhesives can be used to laminate the veneers into lumber, plywood like panels, other laminated strand-based products, and mass timber panels. As shown in FIG. 1, a plurality of the veneers can be laid on top of one another and compressed together with adhesive to create laminated strand veneer lumber. In addition, the lumber created can be laminated together with other lumber with the orientation of the veneers being at perpendicular or other angles, to create cross laminated strand veneer lumber for added stiffness. Manufacturing of the composite wood panel lumber can be performed in the same manner as oriented strand board (OSB) manufacture, except that the wood veneers are utilized instead of single strands. Alternatively, and as discussed in the example below, manufacturing of the composite wood panel can be constructed using techniques common for plywood manufacture, except that individual layers are constructed from a plurality of wood veneers. Strand-based veneers can be arranged horizontally (edge to edge and end to end within a layer) and vertically (in a balanced and symmetric manner to eliminate coupling between bending and tension) to form a laminated strand-based composite of varying width, length, and thickness. Layers can be oriented at varying angles with respect to the longitudinal direction of the end product to engineer a composite material with specific performance The composite wood strand panels are durable for use in construction applications (i.e., they have high moisture and decay resistance and are stiff and strong (i.e., can support loads), etc.). They can be any desired thickness, e.g., from a quarter of inch to ⅜ of an inch in thickness, from ⅜ of inch to 1 or 1 and half inches or up to two feet in thickness or more.

### EXAMPLES

### Materials and Methods

### Strand's Processing and Thermal Modification

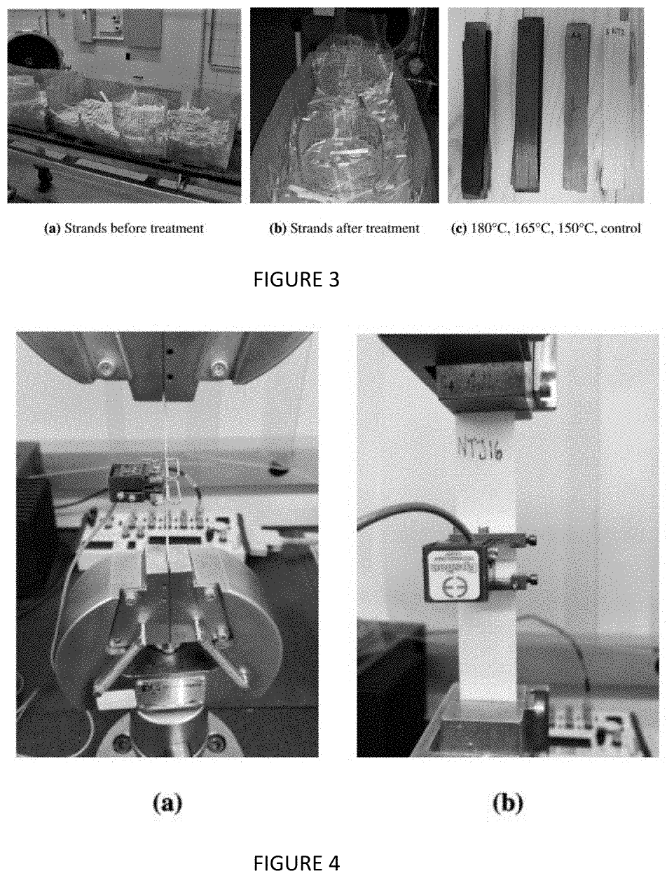

The wood-strands considered in the scope of this work were processed from low-grade lumber classified as ESLP, Engelmann Spruce (Picea engelmannii) and lodgepole pine (Pinus contorta), but it was predominantly small diameter lodgepole pine. Before stranding, lumber was cut into approximately 150 mm slats that were submerged in water for 48+ hours to reach moisture content (MC) of approximately 40% to produce thin strands of uniform width and length with minimal damage using a CAE disc-strander operating at a rotational speed of 500 rpm. The nominal dimensions of the strands were set to be 148 mm by 19.3 mm by 0.380 mm (length·width·thickness). Wood-strands were then allowed to air-dry to a MC of roughly 6-8%. Four sample groups were then randomly selected from the air-dried strands, and each thermally modified (TM) to a different temperature: 150° C., 165° C., 180° C., and a control group. Each TM was performed for a total dwell time of 180 minutes. Additionally, the TM at 165° C. was also done at different levels of dwell time: 45 minutes, 90 minutes, 135 minutes, and 180 minutes. The TM process was conducted in a pilot facility at the University of Minnesota Duluth Natural Resources Research Institute (NRRI) using a 0.5 m³ IWT/Moldrup pressurized autoclave (closed-process). The unit was heated in a stepwise fashion; for instance, it began at approximately 100° C. and was ramped up to 120° C. and maintained for 75 minutes. Subsequently the temperature was increased to 140° C. and held for another 75 minutes before increasing again until the desired temperature was reached and held for a given dwell time (phase I, II, and III of FIG. 2). Some moisture within the wood is eventually converted into steam, which is kept inside the autoclave for the duration of the treatment along with any additional wood degradation products evolved from the wood during the process. The cooling phase was also carried out in a stepwise fashion similar to the heating phase and achieved by spraying a controlled fine mist of water. The cycle ended when a temperature of 110° C. was maintained for 75 minutes (phase IV, V, and VI of FIG. 2). In order to support more effective airflow in the autoclave and among the strands, the strands were placed in stainless steel mesh baskets. FIGS. 3a-b show examples of the baskets with the strands before and after treatment (i.e., thermal modification), and FIG. 3c shows examples of the strands treated at different temperatures for thermal modification. At the end of the process, samples within each treatment were used to compute weight-loss. The TM conditions for each treatment group are shown in Table 1.

TABLE 1
Thermal modification conditions

| Peak | | | Initial | Peak | |
|---|---|---|---|---|---|
| temperature | Dwell time | Total time | wood MC | pressure | Weight-loss |
| 150° C. | 180 min | 13 h 6 m | | 0.32 MPa | 1.13% |
| | 90 min | 15 h 51 m | | 0.44 MPa | not |
| | | | | | determined |
| 165° C. | 135 min | 16 h 12 m | 8% | 0.45 MPa | not |
| | | | | | determined |
| | 180 min | 17 h 23 m | | 0.44 MPa | 4.94% |
| 180° C. | 180 min | 19 h 44 m | | 0.48 MPa | 11.50% |

Mechanical, Physical, and Chemical Effects on Wood-strands from the Thermal Modification Tensile Properties Parallel to the Grain

Young's modulus (E) and ultimate tensile strength (UTS) of the TM wood-strands were experimentally determined via tensile test parallel to the grain. Since no specific standard exists for testing wood-strands in tension, guidelines were followed as per Kohan [17] regarding specimen's geometry and Jeong et al. [18] concerning loading rate. A total of 30 specimens per treatment type were tested. Specimens were visually selected so that they had a uniform width and relatively straight grain or low deviation in grain with respect to the longitudinal axis of the strands. Before testing, the wood-strands were conditioned at 22° C. and a relative humidity (RH) of 65%. The specimen dimensions were measured with an accuracy of ±0.0254 mm and weighed with an accuracy of ±0.01 g. The MC of all specimens was obtained as per ASTM D4442-16 using the oven-dry method. Testing was performed with an Instron load frame equipped with a 2-kip load cell at a loading rate of 0.254 mm/min, and the longitudinal strain was recorded using an Epsilon extensometer with a gauge length of 12.7 mm, Model 3442-0050-010-ST. Wedge action tensile grips were used throughout (see FIGS. 4a-b). Lastly, the density of each specimens was determined and used to account for the effects it may have on the tensile properties.

### Surface Tension and Wettability

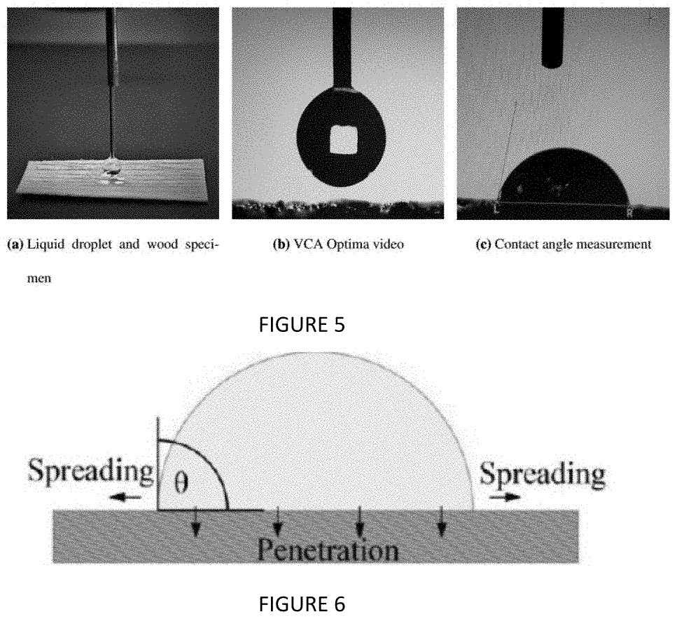

Surface properties of the TM wood-strands were determined using contact angle measurements [19, 20, 21, 22, 23]. Contact angle values were used as an indirect method to compute surface free energy (SFE) and assess wettability of pMDI resin (used in this study to hot-press wood strand composite panels) by means of penetration and spreading rate. FIG. 6 illustrates mechanistically wetting by spreading and penetration. The VCA Optima video contact angle system, as is shown in FIG. 5b, was used to measure advancing contact angle via the sessile drop method (see FIG. 5a).

SFE was computed using the Fowkes method [24, 25, 26], based on Young's equation [27], which states a relation between surface tension of a solid surface and a contact angle it forms with a liquid, and on the Berth hypothesis for the interfacial work of adhesion. Here, Fowkes assumes that SFE of a solid can be expressed as the sum of dispersion interactions (London dispersion forces, namely, electron dipole fluctuations) and polar interactions (such as: polar forces, hydrogen bonds, induction and acid-base components).

First γ^{d} was calculated from equation (1) by measuring the contact angle that a dispersion liquid forms with the solid surface. Then another contact angle was measured using a liquid with both polar and dispersion components, γₗ=γl+−γl, in order to calculate γₛ through equation (2). Here γ corresponds to the SFE, the subscripts ‘s’ and ‘l’ refer to the solid and liquid, the superscript ‘d’ and ‘p’ correspond to the dispersion and polar components, and θ is the solid/liquid contact angle. This method was used throughout with the same set of testing liquid for consistency and comparability of results.

$$\begin{matrix}{γ}_{s}^{d} = 0.25 {{γ}_{i}^{d} ( 1 + cos θ )}^{2} & ( 1 ) \\ {γ}_{s}^{p} = \frac{{[ 0.5 {γ}_{l} ( 1 + cos θ ) - {( {γ}_{s}^{d} {γ}_{l}^{d} )}^{0.5} ]}^{2}}{{γ}_{i}^{p}} & ( 2 )\end{matrix}$$

The two testing liquids used were distilled water (polar dominant component) and diiodomethane from Sigma-Aldrich, 99% assay (dispersion dominant component). A total of three droplets per testing liquid were used for each type of wood-strand, with a total of three specimens per strand group. The contact angle was measured with liquid spreading along the grain direction at a time t=1 sec (time after the liquid is in contact with the solid surface). The droplet dosage was of 3 μl for the distilled water and 0.75 μl for the diiodomethane. The prescribed dosage was based on the maximum amount of liquid that would form a droplet big enough to barely remain at the tip of the syringe to be then picked up by the wood-strand. For the SFE determination, the contact angle θ is taken from the average of the right and left contact angle of the droplet (see FIG. 5c).

Moreover, the penetration and spreading rate of p-MDI resin was determined by means of a dynamic wettability model proposed by Shi and Gardner [20], frequently adopted to study wettability in wood [28, 22, 29, 30]. The model states that a contact angle rate decreases over time because of less spreading and penetration, as described in equation (3). Where θᵢ is the initial contact angle (°), θₑ is the equilibrium contact angle (°), t represents wetting time measured (seconds), and K is a constant indicating the spread and penetration rate of the liquid into the porous structure of wood (1/seconds).

$$\frac{d θ}{dt} = K θ ( \frac{{θ}_{e} - θ}{{θ}_{i} - {θ}_{e}} ) \qquad ( 3 )$$

Measurements were used along the grain direction with a droplet volume of 6 μl. The contact angle was measured at a rate of 4 points/second for at least 80 seconds, assuring to reach the equilibrium contact angle. The experimental values were then fitted to the Shi-Gardner model using the Levenberg-Marquardt algorithm [31] by varying the K-value for each measurement. A total of three droplets per specimen were conducted, with two specimens for each treatment type.

### Moisture Sorption

Water sorption behavior was determined for the TM wood-strands through moisture sorption isotherms at 22±1° C. with a total of seven randomly selected strands per each thermal treatment and control groups. The equilibrium moisture content (EMC) was recorded for each specimen for a RH ranging from 20% to 95% and then used to build the adsorption curves. All weights were recorded with a precision of ±0.001 g. At the end of testing, the dry weight of the strands was determined as per ASTM D4442-16 using the oven-dry method. The experimental data was fitted to the three parameter Guggenheim-Anderson-deBoer (GAB) model [32, 33, 34, 35], expressed in equation (4), to understand the sorption physics. Where Mₘ, C and K (the fitted parameters) refer to the mono-layer water capacity (%), equilibrium constant related to the mono-layer sorption and the equilibrium constant related to the multilayer sorption, respectively. The model coefficients were found using the Levenberg-Marquardt algorithm [31]. This model, based on a multilayer theory, assumes the formation of a monolayer or unimolecular layer tightly bound to the hydroxyl groups of the wood substrate (primary sorbed water). Then, the formation of a multilayer bonded to the mono-layer (secondary sorbed water), assumed to be less strongly bonded than the mono-layer.

$$EMC = {M}_{m} \cdot \frac{{K}_{GAB} \cdot {C}_{GAB} \cdot RH}{( 1 - {K}_{GAB} \cdot RH ) \cdot ( 1 - {K}_{GAB} \cdot RH + {C}_{GAB} \cdot {K}_{GAB} \cdot RH )} \qquad ( 4 )$$

### Degree of Crystallinity

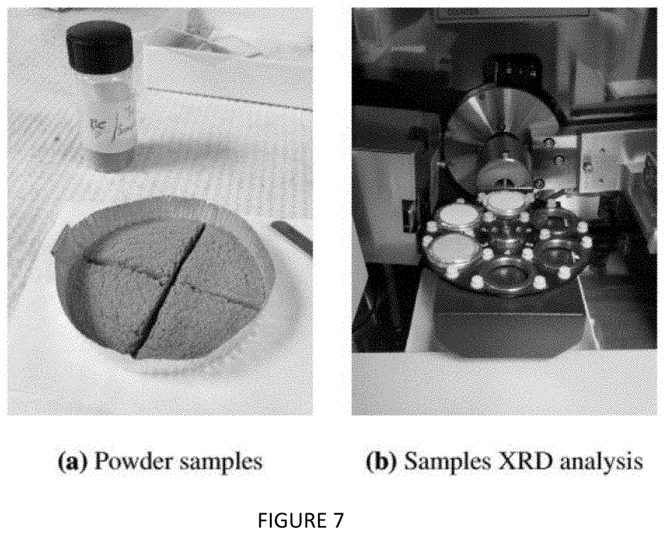

X-ray diffraction (XRD) was used to estimate the degree of crystallinity using the Segal method [36], equation(5). Where CᵣI represents the degree of crystallinity, I₀₀₂ the intensity peak corresponding to the plane in the sample with Miller index 002 found at 2θ≈22° (a.u.), and Iₐₘ the intensity of diffraction of the amorphous region found at a 2θ≈18.5° (a.u.). Before XRD, the wood-strands were ground in a Thomas milling machine and passed through a No. 60 mesh size sieve. XRD measurements were performed using a Rigaku Miniflex600 with a CuKα radiation (λ=1.541 Å) operating at 40 KV and 15 mA. The 2θ/θ angle was measured in a range from 5° to 45° at a rate of 0.057 sec. Lastly, a total of four wood powder samples (FIGS. 7a-b show examples of the samples) were prepared and scanned for each treatment condition.

$${C}_{r} I ( \% ) = \frac{{I}_{002} - {I}_{am}}{{I}_{002}} \times 100 \qquad ( 5 )$$

### Chemical Composition

Two samples of 5 grams (ground, 60-mesh) of known MC per each treatment group were Soxhlet extracted with CH₂Cl₂ (150 mL) for 22 hours to obtain their extractives content gravimetrically in accordance with ASTM D 1108-9623. Furthermore, these samples were later analyzed in triplicate to determine chemical composition of lignin and neutral sugars.

### Manufacture of Wood-strand Composite Panels

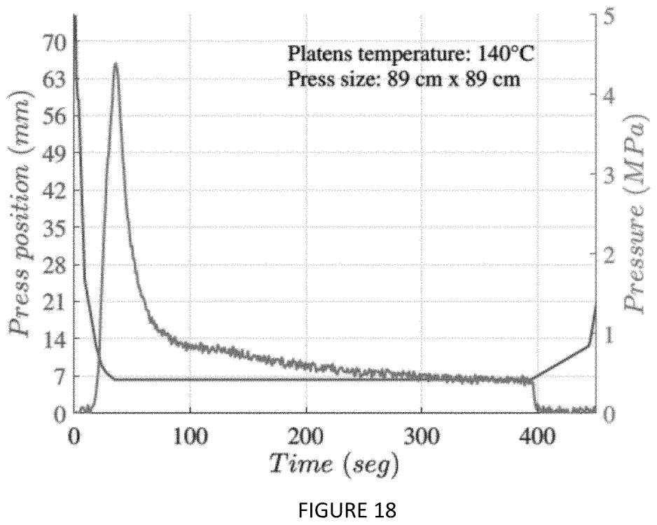

Two sets of wood strand composite panels were fabricated; one set with a 381 mm by 381 mm manual hydraulic press, and the other with a 889 mm by 889 mm hydraulic press controlled by a Pressman control system. The first set was made for preliminary testing, seeking to minimize resources and assure proper manufacturing protocols, while the second set was produced to more closely replicate industry manufacturing practices and further assess other performance parameters in the panels. Before pressing, all the wood-strands were conditioned at 70% RH and 20° C. Polymeric diphenylmethane diisocyanate (pMDI) resin was aerosolized and spray-blended onto the wood-strands in a rotating drum, ensuring a uniform application. The resin content used was 4.5% by weight of dry wood. The strands were then hand-formed into a forming box, which consists of a wood frame with vanes separated 76.2 mm to obtain a preferred orientation of the strands of ±30° in one direction (longitudinal direction) theoretically. The falling distance of the strands to the mat was kept to a minimum to avoid reorientation. Once the mat was fully formed it was hot-pressed at 140° C. for a total curing time, or holding press position, of 360 seconds at a target thickness of 6.35 mm and density of 640 kg/m³. The platen temperature and pressing time used for closing, holding, and opening was kept constant throughout all the panels. After pressing, the panels were edge trimmed and cut accordingly to prepare different sizes of specimens for testing. FIG. 18 shows an exemplary pressing schedule over a period of time.

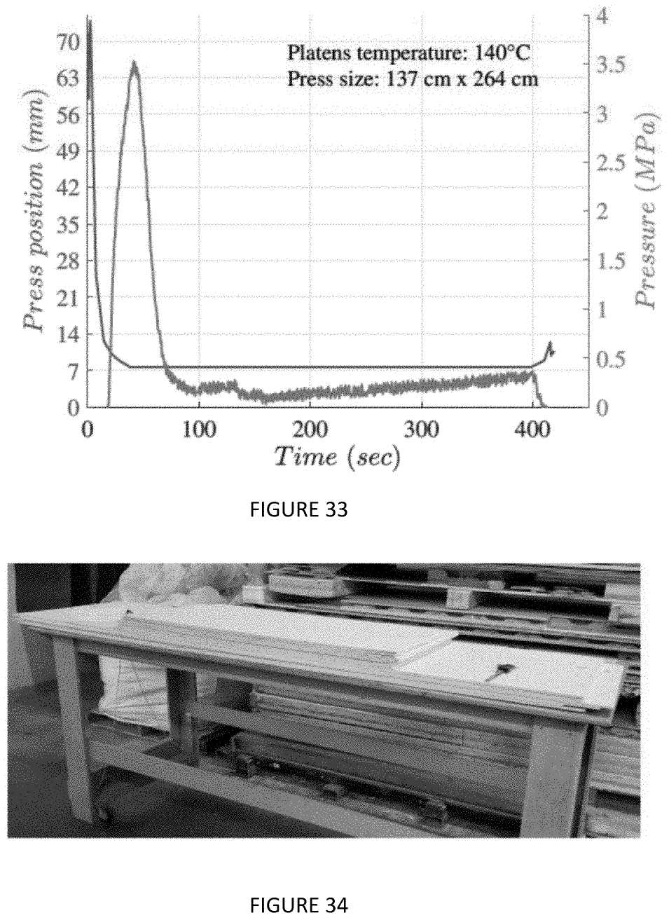

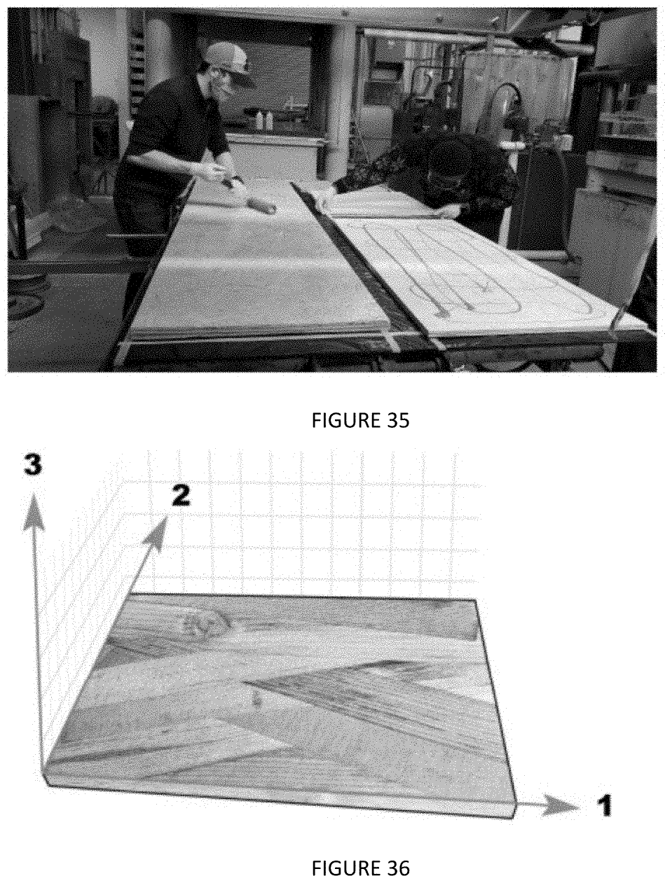

Exemplary manufacture-A total of ten 137 cm by 264 cm by 7.62 mm wood strand plies or panels were hot pressed; five of these plies were manufactured using the control strands and five with thermally modified strands at 165° C. and 180 min dwell time. Similar processes were used for controls for the testing described herein. Before pressing, the thermally modified strands were sprayed with water to reach a MC content of approximately 12%, and the control strands were only sprayed with pMDI resin as they have been conditioned to an MC content of around 12% (thermally modified strands may not be equilibrated to 12% MC as their EMC is around 5% when placed in the conditions that would lead to an MC of 12% for a control strand). FIG. 33 shows a typical graph of mat thickness and ram pressure during the pressing routine. The manufactured panels were then trimmed and cut to specific sizes to manufacture a 15-ply CLSVL beam 2438 mm by 305 mm by thickness and another 15-ply CLSVL 610 mm by 305 mm by thickness, both for each kind of strands, control and thermally modified. The 15-plies were cross laminated, with the outer five plies oriented in the direction of the grain (longitudinal laminates) and five in the core oriented perpendicular to the longitudinal laminates. After trimming and before laminating, each ply was sanded to assure a uniform thickness throughout with a tolerance of ±0.2 mm, and then placed in a conditioning chamber at 16° C. and 75% RH. FIGS. 34 and 35, respectively, show images of the laminates before pressing and the application of a PUR resin (polyurethane resin or other suitable adhesive) between laminates)

### Performance of Wood-strand Composite Panels

### Mechanical Properties

The wood-strand composite panels' local coordinates (1, 2, and 3) are defined in FIG. 36; where axis 1 is parallel to the wood fiber and axes 2 and 3 are orthogonal to 1.

A three-point bending test was used to evaluate the mechanical properties of the wood-strand composite panels along local directions 1 and 2, where bending modulus of elasticity E₁ and E₂ and the out-of-plane shear modulus G_{1,3} and G_{2,3} were computed. To estimate the material properties, the bending specimens were tested at multiple span-to-depth ratios (20, 8.5, 6.5, and 5.5), similar to the procedure established in ASTMD198, with a linear regression between x=(d/l)² and y=(1/Eₐₚₚ) defined by equation (6). Where k represents the shape factor, Eₐₚₚ the apparent modulus of elasticity, Eₛₕ the shear free modulus of elasticity, G the shear modulus, and d and l the panel thickness and the span, respectively. Furthermore, the bending modulus of rupture (MOR) along the local direction 1 was also determined from a three-point bending test as established in ASTM D1037. After testing, the MC of the samples was measured as per ASTM D4442-16 using the oven-dry method. The density of each specimen was then used to account for the effects it may have on the elastic constants and MOR along 1.

$$\frac{1}{{E}_{app}} = \frac{1}{{E}_{sh}} + \frac{1}{kG} {( \frac{d}{l} )}^{2} \qquad ( 6 )$$

### Tension Perpendicular to the Surface (Internal Bond)

Internal bond strength of the wood-strand composite panels was used as a method to evaluate bond performance for the different TM conditions. The test was carried out as specified in ASTM D1037-12. Mean estimates from x-ray vertical density profile (VDP) for each specimen were then used to account for the effects that density may have on bond strength.

### Water Absorption and Thickness Swell

A water absorption and thickness swell (WA & TS) test was conducted as established by ASTM D1037-12 to study the effect of TM on moisture intake. Moreover, these results were indirectly used to infer changes in dimensional stability. Measurements of WA & TS were taken for each specimen 2 hours after submersion in water and then again after 22 hours. After testing, the MC of the samples was measured as per ASTM D4442-16 using the oven-dry method.

### Decay Resistance of Wood-strands and Wood-strand Composite Panels

The different types of TM wood-strands and manufactured panels were tested for their resistance to fungal decay following AWPA E10-16 using laboratory soil-block cultures. Wood-strand specimens were exposed to the brown rot fungus G. trabeum for a total time of 39 days, while the panels were exposed to G. trabeum for 55 days. The wood-strands were cut to 90 mm by 19 mm by 0.380 mm (nominal thickness) before being exposed to the fungi. Moreover, some panel specimens were cut into 12.5 mm by 12.5 mm by 7 mm before fungi exposure. As a way of comparison, untreated and alkaline copper quaternary (ACQ) treated southern yellow pine specimens were prepared and exposed to the same conditions. However, ACQ-treated specimens were exposed to the fungi for 18 weeks. A total of five replicates were tested for each treatment type for both wood-strands and panels.

### Statistical Analysis of Strands Characterization and Panels Performance

All statistical analyses were performed with SAS software using a generalized linear model. For the mechanical properties, the effects of the density of each sample were considered as a covariate. Furthermore, pairwise Tukey's multiple comparison procedure was used to compare significantly different groups across different analyses.

Out-of-plane Flexural Performance of Cross-laminated Strand Veneer Lumber (CLSVL) Experimental Design and Manufacture of CLSVL

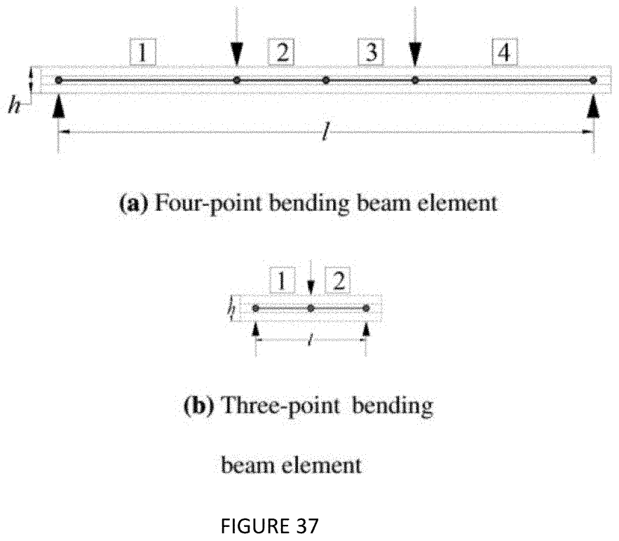

To evaluate the shear performance of out-of-plane bending of CLSVL made of control and TM wood-strands, two different shear type failure bending specimens were prepared with different span-to-depth ratios, l/h, and loading configurations. One with l/h≥20 tested under four-point bending with equivalent concentrated loads symmetrically applied, and the other with l/h≤5 loaded at mid-span. The test layout for the four-point bending specimens is shown in FIG. 37a. In this case, the total span length was 2286 mm, with a separation between the loads of 762 mm The mid-span deflection of the neutral axis was measured using a string pot with a 250 mm stroke held in a U-shaped yoke suspended on two nails placed on the neutral axis at both reaction points. The setup for the three-point bending specimens is shown in FIG. 37b. The total span length for this case was 479.4 mm, and the mid-span deflection was recorded with a 25.4 mm stroke LVDT.

Due to limited availability of TM material, only the 165° C. with 180 min dwell time treatment was used for the fabrication and study of CLSVL. For the fabrication of the CLSVL beams, a total of ten 1220 mm by 2440 mm by 7.62 mm wood-strand panels were hot-pressed using a 1372 mm by 2642 mm press controlled by a Pressman control system, following the same procedure as with the 381 mm by 381 mm press panels previously described. Five of these panels were manufactured using control strands and five using TM strands. The wood-strands were first conditioned at 16° C. and 75% RH Immediately prior to the application of pMDI resin, the wood-strands were sprayed with water to reach a MC 12%, as needed. The manufactured panels were then trimmed and cut to specific sizes to manufacture 15-ply CLSVL beam 2438 mm by 305 mm by thickness and another 15-ply CLSVL 610 mm by 305 mm by thickness for each kind of strand, control and TM. The 15-ply were cross laminated, with the outer five panels oriented along the local direction 1, from FIG. 36, and with the five inner panels oriented along the local direction 2, transversal to the other panels. After trimming and before laminating, each panel was sanded to assure a uniform thickness throughout with a tolerance of ±0.2 mm and then conditioned at 16° C. and 75% RH. The CLSVL beams were cold pressed using polyurethane resin (PUR), hand rolled at a rate of 0.17 gr/m² within each laminate under an assembly time of less than 60 min and then pressed for 180 min, as established by the resin manufacturer.

### Modeling of CLSVL

Although the out-of-plane bending behavior of similar mass timber products, like cross-laminated timber, is well understood, there is a need to revise lamination beam theories and validate them for this case, considering that two major aspects have been changed: geometry and material. Geometry changes involve the use of different thickness-to-width ratios of each ply. Material changes take into consideration general modifications to the material through TM.

A three step modeling procedure was used in the investigations. At first, the Shear Analogy Method (SAM), described in the CLT Handbook and other works [37, 38], was implemented to compute effective section properties of the beam element. This method accounts for the effects of shear deflections derived from the Timoshenko beam theory (TBT) and separately the pure flexural deflections derived from Euler-Bernoulli beam theory (BBT). From this, the effective bending stiffness, (EI)_{eff} is derived, arriving at equation (7). Likewise, the out-of-plane effective shear stiffness, (GA)_{eff} is computed with equation (8).

$$\begin{matrix}{( EI )}_{eff} = {\sum }_{i = 1}^{n} {E}_{i} {b}_{i} \frac{{h}_{i}^{3}}{12} + {\sum }_{i = 1}^{n} {E}_{i} {A}_{i} {z}_{i}^{2} & ( 7 ) \\ {( GA )}_{eff} = {{α}^{2} [ \frac{{h}_{1}}{2 {G}_{1} {b}_{1}} + {\sum }_{i = 2}^{n - 1} \frac{{h}_{i}}{{G}_{i} {b}_{i}} + \frac{{h}_{n}}{2 {G}_{n} {b}_{n}} ]}^{- 1} & ( 8 )\end{matrix}$$

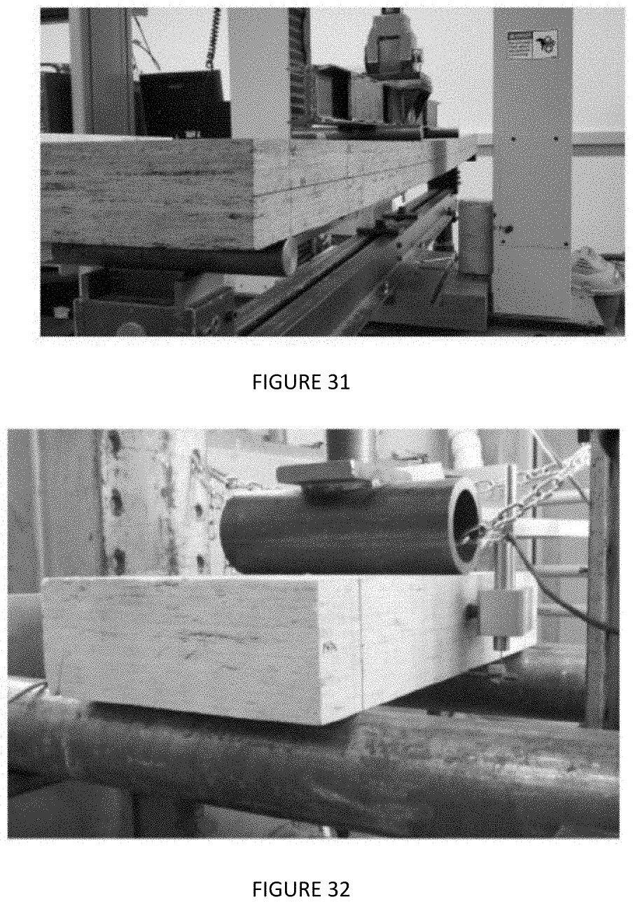

Here, Eᵢ is the modulus of elasticity, bᵢ and hᵢ are the width and thickness of each laminate, respectively; Aᵢ is the cross sectional area of the ith laminate; zᵢ is the distance from the centroid of the ith laminate to the centroid of the beam's cross section; Gᵢ is the shear modulus for the ith laminate, and α is the distance between the centroids of the lower and upper layer. On the second step, the effective bending and shear stiffness are used in a simplified four degree of freedom Timoshenko beam element [39], equation (9), where k represent the shape factor, and L the length of each finite element. This was then implemented in a finite element formulation in MATLAB software, and used to determine the apparent bending stiffness, Eₐₚₚ, for the three- and four-point bending CLSVL elements. The four-point bending beam element was discretized into 4 elements, as shown in FIG. 37a, so that the mid-span deflection could be directly calculated; while the three-point bending element was discretized into 3 elements, as shown in FIG. 37b. FIGS. 31 and 32, respectively, show the actual set ups for the three- and four-point bending tests.

$$K = \frac{{γ ( EI )}_{eff}}{β {L}^{3}} [ \begin{matrix}12 & 6 L & - 12 & 6 L \\ & 4 {L}^{2} ( 1 + \frac{3}{γ} ) & - 6 L & 2 {L}^{2} ( 1 - \frac{6}{γ} ) \\ & & 12 & - 6 L \\ symetric & & & 4 {L}^{2} ( 1 + \frac{3}{γ} )\end{matrix} ] \\ γ = \frac{{k ( GA )}_{eff} {L}^{2}}{{( EI )}_{eff}} \\ β = γ + 12 \qquad ( 9 )$$

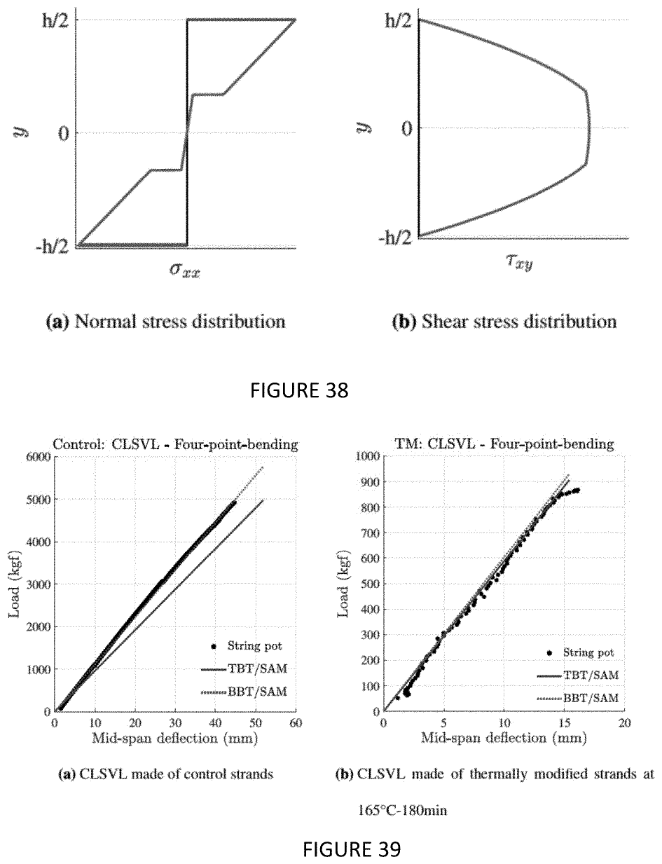

Finally, the normal and shear stress distribution across the cross section of the CLSVL elements were calculated using an equivalent transform section through equations (10) and (11).

$$\begin{matrix}{σ ( y )}_{i} = \frac{My}{{I}_{transformed}} {n}_{i} & ( 10 ) \\ {τ ( y )}_{i} = \frac{V {\int }_{A} ydA}{{bI}_{transformed}} {n}_{i} & ( 11 )\end{matrix}$$

Where M is the bending moment, y is the distance to the neutral axis, I_{transformed} is the second moment of inertia of the transformed section, nᵢ represents the modular ratio of the i^{th} laminate, V is the shear force, A the cross sectional area, and b is the width of the CLSVL element. The theoretical normal and shear stress distributions for the layout of a CLSVL according to the invention (e.g., 15 ply laminate where outer five plies on the top and bottom are oriented in the longitudinal direction and the five plies in the core are oriented in the transverse direction with respect to the laminate axes) have the shapes as shown in FIGS. 38a-b.

### Results

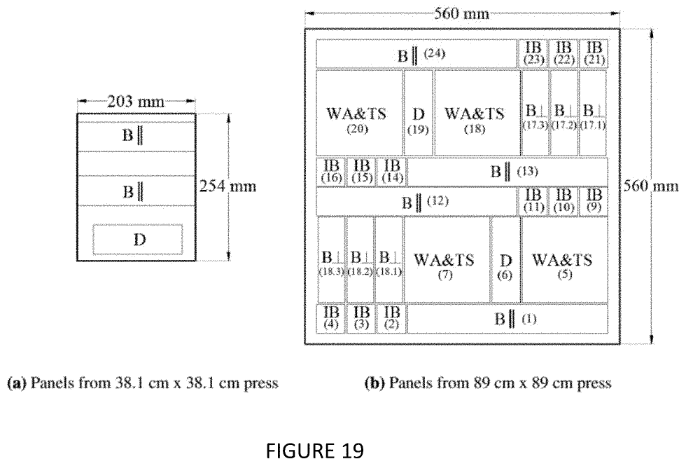

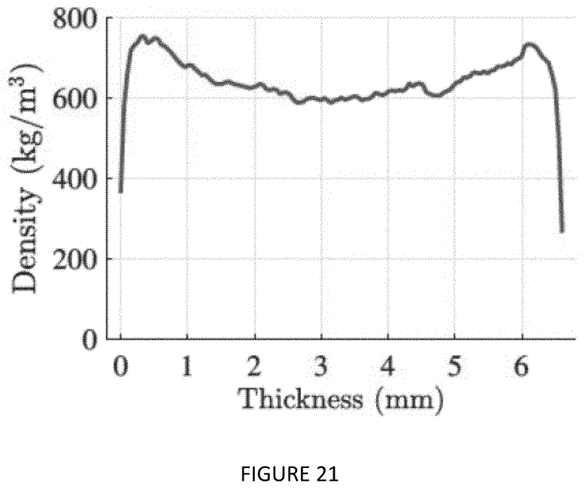

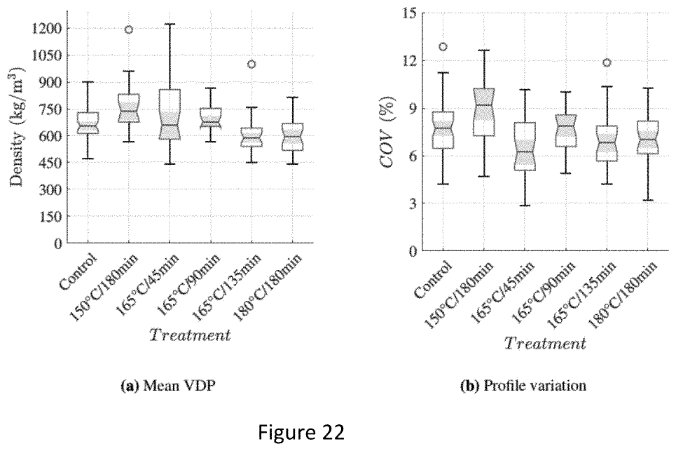

FIG. 19 shows the respective trimmed sizes used in the testing. B with parallel lines represents bending aligned in the longitudinal direction of the strands. B with perpendicular lines represents perpendicular with respect to the strands. IB is used for internal bond and is also used for vertical density profile (VDP). FIG. 21 shows a typical vertical density profile through the thickness of the panels. FIGS. 22a-b show the vertical VDP variation for various temperatures. WA and TS are water sorption and thickness swell. As observed from the means of the VDP across the different panels with different types of thermally modified strands, the density remains consistent and remains around 640 kg/m³, which is an exemplary target density. The variation within the profile across the different types of panels is consistent. These results show a uniform density along the thickness of the panel, which further leads to uniform properties within and across the panels produced according to the invention.

Mechanical, Physical, and Chemical Effects on Wood-strands from the Thermal Modification

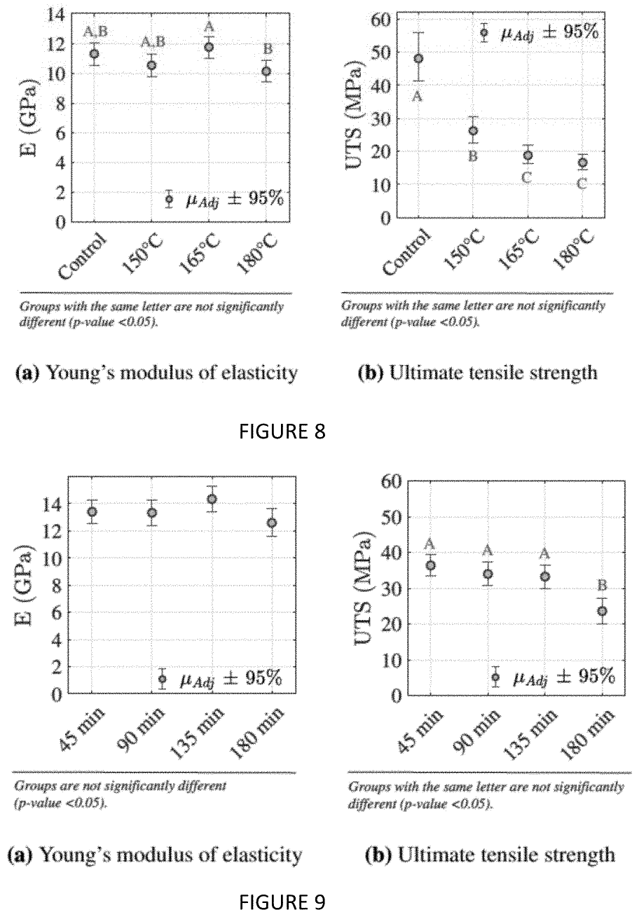

Results from mechanical properties obtained via tensile tests are shown in FIGS. 8a-b and 9a-b. Overall, TM intensity affected the tensile strength; with higher treatment temperatures yielding lower strength. This drop becomes less evident at higher TM temperatures. Whereas, the dwell time did not have a significant effect on tensile strength until reaching 180 min, with a difference as compared with the control group coming from the treatment temperature of 165° C. On the other hand, Young's modulus (E) was mostly unaffected by the TM, with an apparent increase up until a temperature of 165° C. and with a drop at a treatment temperature of 180° C. Here again, dwell time did not have a significant effect. Similar results on strength and modulus of elasticity after thermal modification have been reported elsewhere [6, 40, 41, 42].

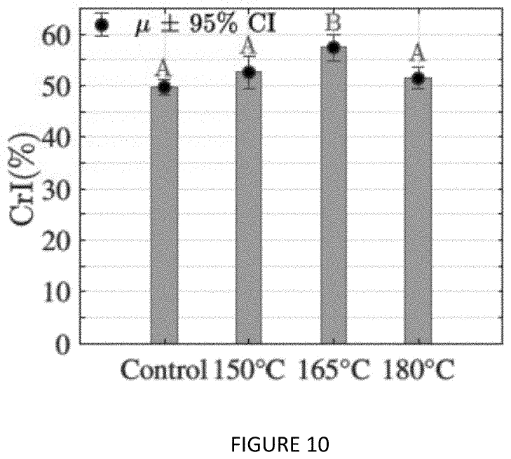

Comparable results to E were observed in the CᵣI (FIG. 10), with a slight increase and a subsequent drop as TM temperature increases, which can therefore justify the apparent change in Young's modulus despite the degradation of wood constituents through the treatment. For instance, Bhuiyan, Hirai and Sobue [43] also reported an initial increase in the degree of crystallinity under pressurized treatment conditions as these conditions intensify, with a subsequent drop. Esteves and Pereira [6] recalled that during TM cellulose crystallinity is increased provided the amorphous cellulose degrades.

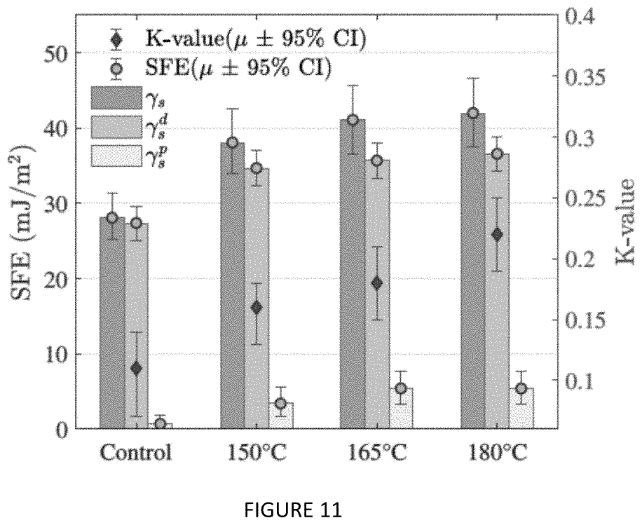

Surface Free Energy (SFE) was found to increase with thermal treatment temperature (FIG. 11); however, the contact angles obtained at treatment temperatures of 150° C. through 180° C., which were used to compute SFE, were found not significantly different (Table 2). Based on this, there is not enough evidence to infer that SFE keeps increasing as temperature increases after 150° C.; this is especially the case for 165° C. and 180° C. Yet, it is important to point out the trend in the increase of SFE. The same can be said about the polar ratio, γP/γ, which increases from 2.5% to about 13% as temperature increases, with a significant difference only between the control group and the TM strands. Now, despite the increase in SFE, the wood surface becomes more hydrophobic, as reflected with the increase in the measured contact angle with water (Table 2).

TABLE 2
Contact angle of different testing liquids on TM strands; varying
temperature with 180 min dwell time

| Contact angle [°] | | | | | | |
|---|---|---|---|---|---|---|
| | | Distelled water | | Diiodomethane | | |
| | μ | SD | Letter grouping | μ | SD | Letter grouping |
| Control | 119.5 | (6.6) | A | 62.1 | (4.6) | A |
| 150° C. | 127.4 | (8.4) | AB | 49.2 | (10.3) | B |
| 165° C. | 133.5 | (7.6) | B | 47.4 | (6.5) | B |
| 180° C. | 132.7 | (11.1) | B | 45.7 | (3.5) | B |

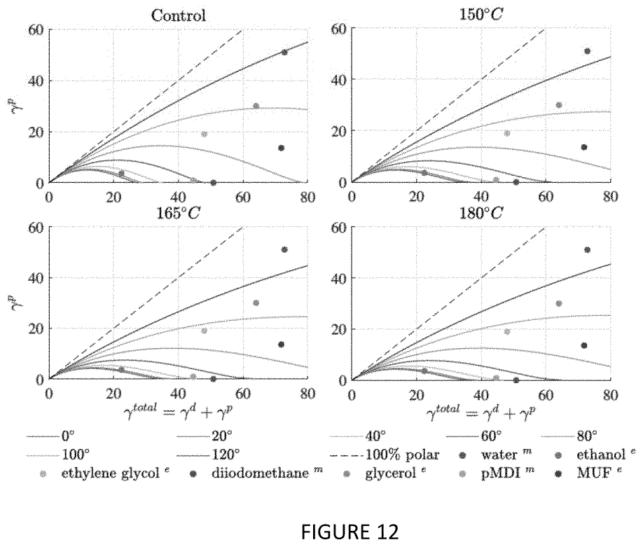

Similar to SFE, the K-value obtained from the Shi and Gardner model increases as TM temperature increases (FIG. 11). This result implies a higher penetration and spreading of pMDI resin, and thus a gained wettability; this is likely attributed to an increase in SFE porosity within the wood. Kutnar et. al. [44] also reported an increase in contact angle with water and in SFE as TM intensity increased. Likewise, Croitoru et. al. [45] found an increase in SFE and in polar ratio as treatment conditions became more intense. FIGS. 12a-d illustrate the wetting envelope for various liquids at different temperatures, both measured and computed.

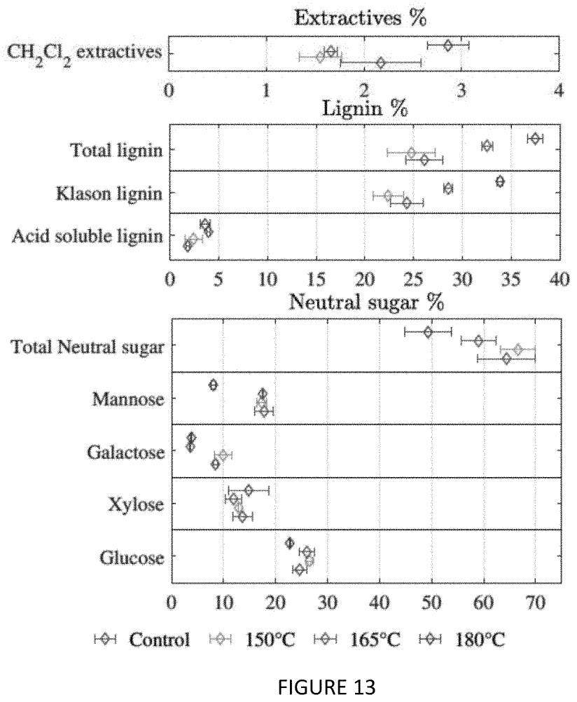

Furthermore, the chemical composition analysis showed that as treatment temperature increased, the changes in composition became more evident (FIG. 13). However, at low treatment intensity (e.g. 150° C.) no evident changes occur. For the other treatments, the most apparent change is in the relative increase of total lignin, mostly with Klason lignin and to a much less extent acid-soluble lignin. This relative increase in lignin content becomes possible due to the partial removal of sugars that make up hemicelluloses, as it can be observed from the reduction of total neutral sugars. Here again, the decrease of hemicelluloses appears proportional to the TM temperature, with the most intensive treatment exhibiting the biggest decrease. This change is expected to occur, and is in fact one of the biggest objectives of wood TM, as it is believed that this contributes largely to the increased hydrophobicity and fungal decay resistance 11, 10. It is interesting to note that the reduction of hemicelluloses during the TM process is not as high as in the case of other wood TM processes such as hot water extraction (HWE) [1]. The removal of hemicelluloses in HWE results in part from the extraction of water after the process. However, with the TM process used in the scope of this work (i.e., in a partially inert environment that is a closed system at higher pressure), the hemicelluloses are not “washed” after the process. The presence of some moisture in the materials under treatment helps the partial removal of hemicelluloses via hydrolysis. However, the use of high pressure in the equipment increases the water-boiling point, which avoids drastic water evaporation and part of the moisture remains in the wood cells, thus avoiding the removal of higher percentages of hemicelluloses. Altgen, Willems and Militz [46] also observed this phenomenon and noted that elevated pressures during treatment prevent the excessive vaporization of wood degradation products.

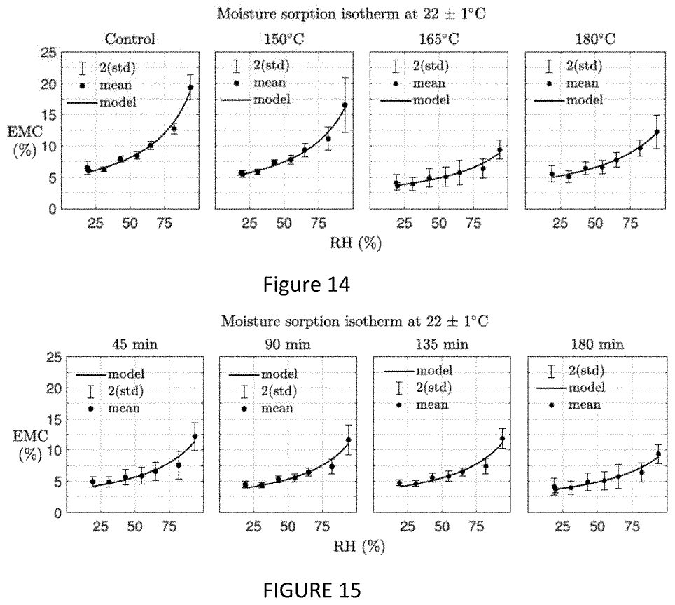

On the other hand, the absorption behavior of the TM strands can be examined by observing the sorption isotherms for strands modified at different temperatures and dwell times (FIGS. 14 and 15). These isotherms show that the sorption capacity of the TM wood diminishes with increasing treatment temperature (FIG. 14). While dwell time does not impart a significant change in the sorption until it reaches 180 min (FIG. 15). An interesting observation arises when examining the absorption curve of wood-strands modified to 165° C./180min, which shows a lower absorption than the wood-strands treated at 180° C./180min. This is unexpected as it is believed that higher the treatment intensity results in lower sorption capacity. However, this could be influenced by a higher degree of crystallinity found in the group treated at 165° C./180min. For instance, several authors noted that an increase in crystallinity results in a lowered accessibility of OH-groups to water molecules [47, 48, 49]. Nevertheless, it is difficult to assure a lowered sorption curve at the 165° C. treatment over the 180° C. treatment, since the variability of results reflects that both curves could very well be similar. When fitting the measured points to the GAB model, the C parameter could not be determined given that there was not enough data in the 5-15% RH range. The other parameters are shown in Table 3; these also reflect a drop in sorption with less mono-layer water capacity and a lowered equilibrium constant related to the multilayer sorption. Another important factor that could limit water absorption intake is the changes in the chemical composition of the TM wood. For instance, higher lignin content and lower hemicellulose content are responsible for the reduced water affinity. It is known that lignin is hydrophobic and hemicelluloses are hydrophilic. Therefore, higher amounts of lignin and lower amounts of hemicelluloses promote hydrophobicity in the materials.

TABLE 3
GAB parameters for TM wood-strands

| Temperature | Dwell time | Mm | K_{GAB} | R_{andj}² |
|---|---|---|---|---|
| Control | | 0.049 | 0.787 | 0.969 |
| 150° C. | 180 min | 0.047 | 0.755 | 0.925 |
| 165° C. | 45 min | 0.036 | 0.732 | 0.821 |
| 165° C. | 90 min | 0.034 | 0.739 | 0.891 |
| 165° C. | 135 min | 0.035 | 0.730 | 0.883 |
| 165° C. | 180 min | 0.032 | 0.678 | 0.777 |
| 180° C. | 180 min | 0.044 | 0.681 | 0.897 |

### Performance of Wood-strand Composite Panels

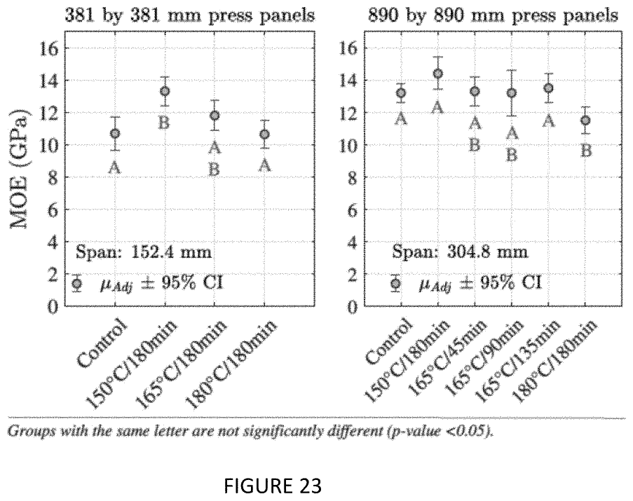

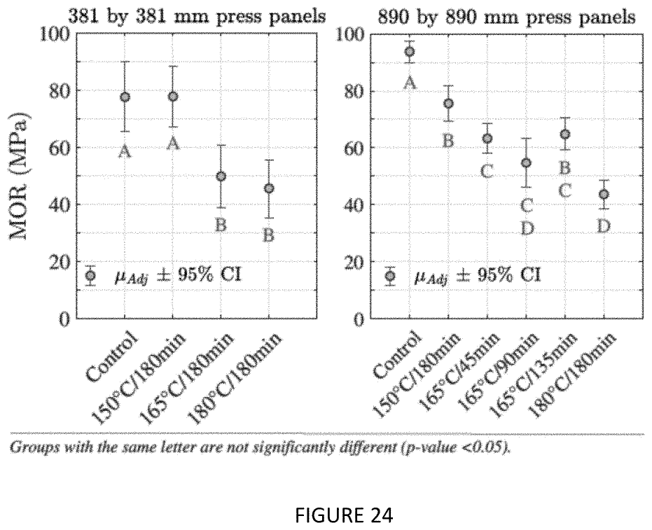

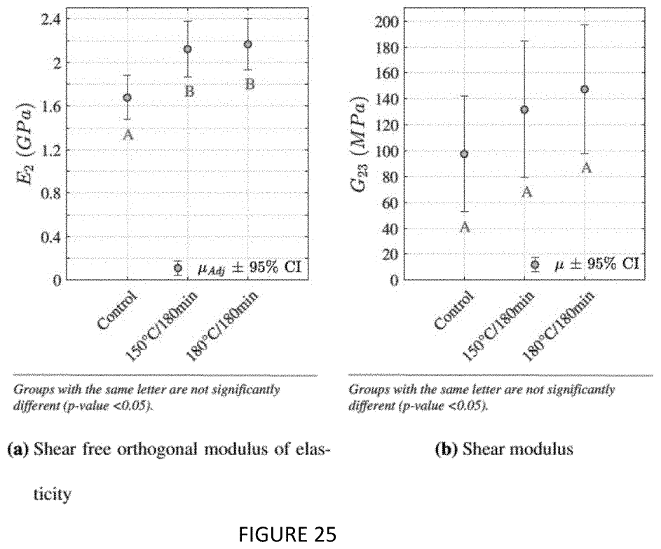

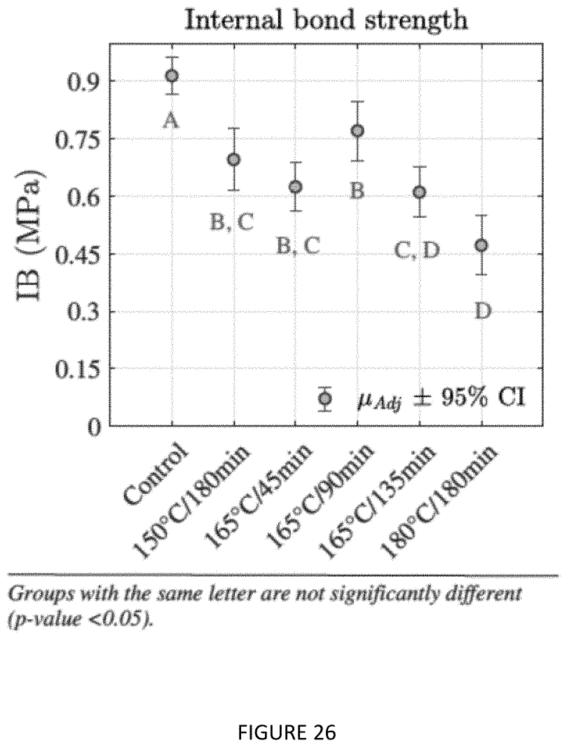

Modulus of elasticity data from static three-point bending tests are shown in FIG. 23, where two sets of results are differentiated. The first, corresponding to the figure on the left, are the results from the 381 mm by 381 mm press panels. Since the final trimmed size of these panels were 203.2 mm by 254 mm, bending specimens parallel to the grain direction of the wood-strands were limited to a free span length of 152.4 mm. The second set of panels corresponding to a 889 mm by 889 mm press, 304.8 mm span specimens were tested along the grain direction of the strand. As expected, there is some difference between the two different spans. This is caused by shear deflection, with shorter span-to-depth ratios leading to smaller apparent modulus of elasticity values. Despite this difference, the effects of TM are similar in both span lengths. As noted, TM causes a slight stiffening of the material at lower modification intensity, with the effect reduced as the intensity increases. This behavior is also observed in the tensile Young's modulus of the TM wood-strands (FIGS. 8a-b and 9a-b). Here again, this stiffening effect may be explained by the increased relative degree of crystallinity of strands as previously discussed. Nevertheless, the modulus of rupture decreases as TM intensity increases (FIG. 24). This is also observed for the case of wood-strands with ultimate tensile strength (UTS) (FIGS. 8a-b and 9a-b). Similar to the UTS values on wood-strands, the decrease in strength is largely due to the degradation of hemicelluloses and possibly of some cellulose during the TM process. However, the positive correlation between density and MOR values (p-value <0.0001 from model utility test) suggests that to some degree densification could help minimize the strength loss for panels. Moreover, Laine et al. [50] found evidence that TM may help reduce the counterproductive spring back effect from hot pressing. Furthermore, shear free modulus of elasticity (E₂) and shear modulus (G₂₃) results are shown in FIGS. 25a and 25b, respectively. As in the case with MOE parallel to the grain direction, MOE₂ also exhibits a slight increase with TM. On the other hand, there is not enough evidence to suggest there is an increase in G₂₃ with TM. Internal bond (IB) strength results (FIG. 26) show that TM has a negative impact on IB values. A trend seems to exist that higher TM intensity results in lower IB strength. For instance, MC in the wood-strands could affect these results, since pMDI resin used in the manufacture of the panels uses water during the curing reaction. Guangbo and Yan [51] mentioned that there is a significant effect on cure kinetics of isocyanate with moisture in wood, where reactions with water are dominant over reactions with hydroxyls found in wood. An increase in shear strength with higher MC during hot pressing was also found by Solt, et. al. [52]. Thus, the addition of water to the wood-strands could help improve the bond. This practice could be easily implemented into the manufacturing process as water can be sprayed before hot pressing. However, it is also important to note that Guangbo and Yan found that MC over 12% no longer had a significant effect on the cure kinetics.

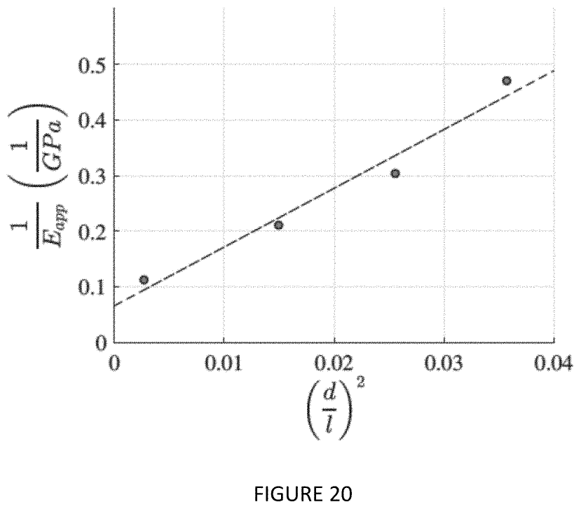

FIG. 20 shows an example for determination of out-of-plane shear modulus by means of a variable span bending test. Here, the span-to-depth ratios were 20, 8.5, 6.5, and 5.5 in order to construct a graph from which the estimated shear free modulus of elasticity (E_{s,f}) and shear modulus (G) are identified by determining the slope and intercept of the linear regression of the measured data points.

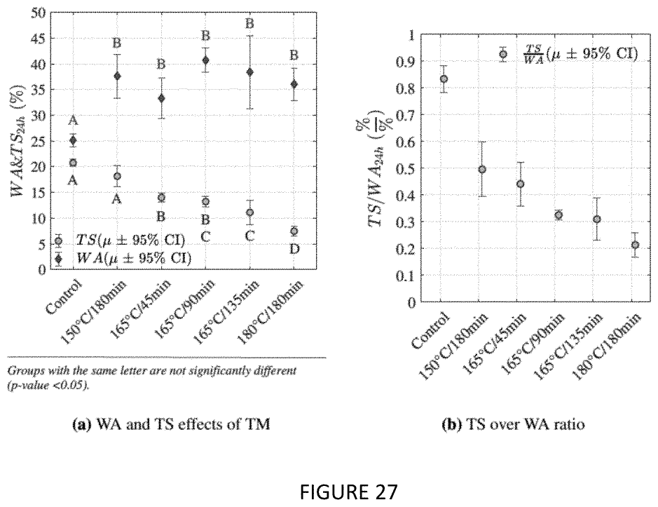

Water absorption (WA) and thickness swelling (TS) results after 24-hour water submersion are shown in FIG. 27a. Here, WA increases with TM, yet there is no evidence that it keeps increasing as treatment intensity further increases. This change may be due to increased porosity within the wood substrate after undergoing TM. On the other hand, TS values are significantly reduced as TM intensifies. When this is seen in terms of TS over WA ratio (FIG. 27b), it can be inferred that the water in TM wood does not necessarily account for physical changes in the wood cell, rather it is found there as free water within the voids of wood. This may be explained by the reduction of available OH groups with the TM wood-strands. This behavior is similar to the sorption reduction on the TM wood-strands (FIGS. 14 and 15).

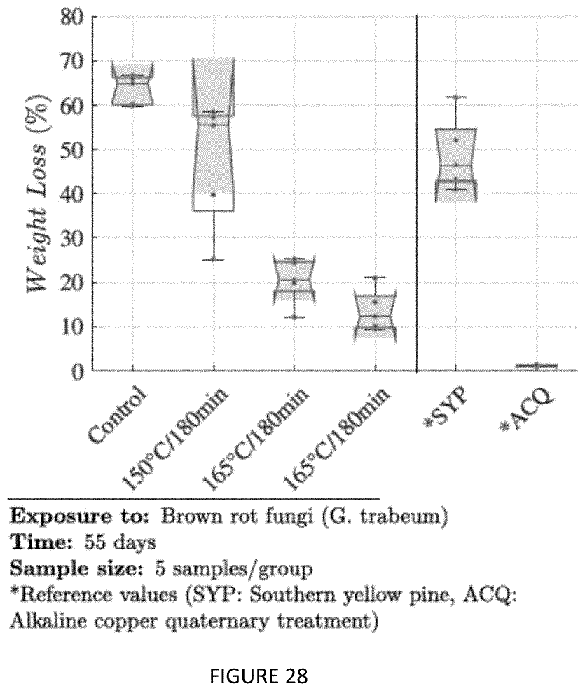

FIG. 28 shows weight loss from a fungal decay test on 381 by 381 mm press panel specimens. In this case, southern yellow pine (SYP) and ACQ-treated SYP specimens were used as benchmarks. The ACQ-treatedSYP is more resistant to the G. trabeum fungus than panels manufactured with thermally modified wood. However, in summary, thermal modification significantly improves the resistance to fungi. This, paired with the findings that thermally modified wood becomes more hydrophobic demonstrates improved long-term durability.

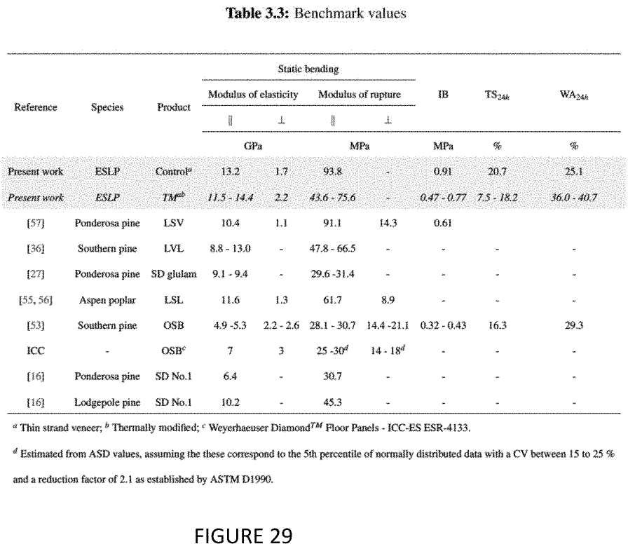

As a way of comparison, some benchmark values from different types of products are presented in FIG. 29. Weight and Yadama [53] developed a laminated strand veneer (LSV) with wood species and strand geometry similar to the panels in the scope of this work, with a difference that phenol-formaldehyde (PF) resin was used instead of pMDI and the thickness of the laminates was 3.2 mm As observed, the control group performed comparable to the LSV from Weight's work, although higher bending MOE values parallel to the orientation of the strands and IB strength values were obtained here. The bending performance of southern pine laminated veneer lumber (LVL) used for structural proposes has lower MOE values than the control and TM wood strand panels and similar MOR values to the panels manufactured from strands thermally modified using the most intense treatment (180° C. and 180 min dwell time). Glue laminated timber manufactured from small-diameter ponderosa pine (which is very similar among the wood species used in this work) has overall lower MOE and MOR values. This helps to give perspective to the improved mechanical performance obtained from this wood composite technology. Laminated strand lumber (LSL), frequently used for structural elements in trusses, headers, wall studs, roof beams, and rafters has lower MOE values and about 35% higher MOR values than panels manufactured from strands thermally modified using the most intense TM treatment. Yet, as previously mentioned, MOR values may be improved through densification. It is also worth mentioning that the wood species for the LSL values reported is aspen poplar, which generally has higher mechanical performance values than ponderosa and lodgepole pine [54]. Two different oriented strand board (OSB) products were also used as reference. One corresponds to Southern pine species, which has lower MOE, MOR and IB strength. WA and TS after 24 hour water submersion is within the same range as the control group;

however, the TM composite for this work has a reduced TS. The other OSB used as a reference is a commercially available premium product, which still has overall lower mechanical performance Lastly, two No. 1 visually-graded small-diameter dimensional lumber ponderosa and lodgepole pine MOE and MOR values are presented, reflecting a lower performance than the TM panels.

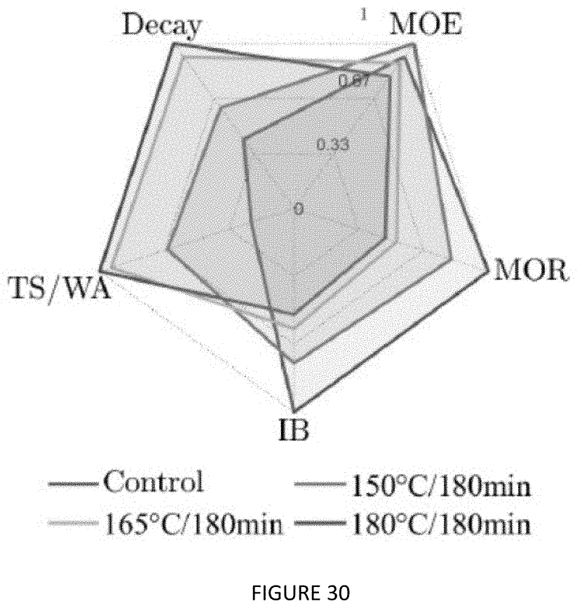

FIG. 30 shows a radar graph where the mechanical and durability performance (e.g., water and decay resistance) can be examined The chart was developed by normalizing each area examined in terms of the maximum for the case of MOE, MOR and IB strength, and in terms of the minimum for weight loss after fungal decay tests and the TS-to-WA ratio. With this in mind, it can be observed that the control panels pose high mechanical performance, but poor decay and water resistance. On the contrary, as thermal modification temperature increases, the decay and water resistance are greatly improved. Consequently, from the overall results it is found that the thermal modification at 165° C. and 180 min dwell time is almost as effective as the most intensive treatment conditions used (180° C. with 180 min dwell time) with regard to durability and with slightly higher mechanical performance. Additionally, the 165° C. and 180 min dwell time requires less energy and overall treatment time than the more intense treatment. Thus, in some applications, the 165° C. and 180 min dwell time treatment may be advantageously used for the fabrication of mass timber products in the form of cross laminated strand veneer lumber.

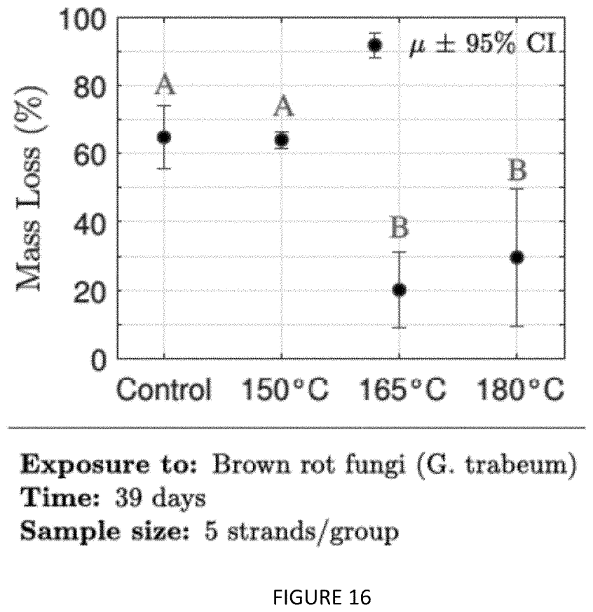

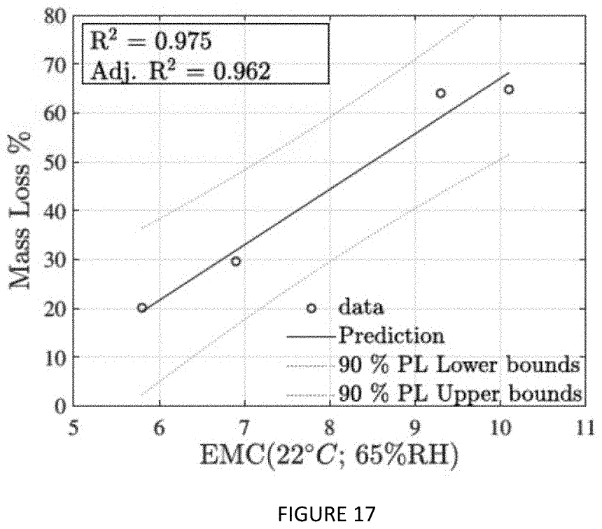

Results from accelerated decay tests with the different types of panels are shown in FIGS. 16 and 17. As temperature during TM increases, the material becomes more resistant to the brown rot fungus G. trabeum. This is the case for both wood-strands (FIG. 16) and panels manufactured from the TM strands (FIG. 17). For the case of panels, two additional groups were also examined for comparison: control southern yellow pine (SYP) and ACQ-treated SYP. The ACQ treatment is more resistant to G. trabeum fungi than panels manufactured with TM wood. Yet, TM significantly improves the resistance to fungi. This, paired with the findings that TM wood becomes more hydrophobic suggests improved long-term durability.

Out-of-plane Flexural Performance of CLSVL

A preliminary bending test performed across directions 1 and 2 on the 1220 mm by 2440 mm panels showed a deviation from MOE₁ and MOE₂ obtained from the smaller panels (FIGS. 23, 24, and 25a-b). For instance, MOE₁≈7 GPa and MOE₂≈3 GPa were obtained, with an MOE₁/MOE₂ ratio of 2.33. On the other hand, the MOE₁/MOE₂ ratio from the 890 mm by 890 mm press panels was found to be between 7 and 8; this suggests a strand orientation issue while forming the larger size panels. The modeling of the CLSVL was implemented with the new material properties (MOE₁=7 GPa and MOE₂=3 GPa), since it was fabricated with the larger panels. Yet, it is worth mentioning that the bending properties previously obtained, from the smaller panels, should be theoretically achieved. On the other hand, G₂₃ and G₁₃ were found to be similar; it is therefore assumed that this property is not affected from forming. For modeling, a G₂₃=G₁₃=0.1 GPa was used for the CLSVL manufactured from control strands, while a G₂=G₁₃=0.13 GPa was used for the CLSVL made of TM strands at 165° C./180 min.

TABLE 4
Out-of-plane bending results

| | | | Apparent modulus of elasticity, Eₐₚₚ (GPa) | | | |
|---|---|---|---|---|---|---|
| | Beam | | | Predicted | | τ₁₃ |
| Loading condition | type | l/h | Measured | SAM/TBT | SAM/BBT | (MPa) |
| Four-point-bending | Control | 20.8 | 11.91 | 11.82 (−0.8%) | 13.70 (15.0%) | 0.965 |
| | TM | 24.2 | 12.16 | 12.56 (3.3%) | 13.70 (12.7%) | — ^{a} |
| | | 4.4 | 1.43 | 1.21 (−15.4%) | 6.85 (379.0%) | 1.207 |
| Three-point-bending | Control | 4.4 | 1.16 | 1.21 (4.2%) | 6.85 (489.2%) | 1.724 |
| | TM | 5.0 | 1.92 | 1.88 (−2.2%) | 6.85 (256.3%) | 1.034 |

SAM/TBT: Shear Analogy Method in conjunction with Timoshenko Beam Element; it accounts for shear deflection.
SAM/BBT: Shear Analogy Method in conjunction Euler-Bernoulli Beam Element; neglects shear deflection.
Values presented in parenthesis are the relative error from the measured value
^{a}Premature failure at PUR glue line

Table 4 shows the results from the out-of-plane bending in the 15-ply CLSVL specimens. The bending stiffness of the CLSVL beam made of control strands, with a l/h of 20.8, was accurately predicted with the model that incorporates shear deflection (SAM/TBT). In the same way, the SAM/TBT model effectively predicted the properties of the CLSVL beam made of TM strands, with an l/h of 24.2. The shear free model (SAM/BBT) was also able to predict the bending stiffness of the beam elements with a l/h≥20 with an error greater than 10% when contrasted with the measured values. This difference is caused mostly by the relative low out-of-plane shear modulus of the material. Likewise, the bending stiffness of the CLSVL beams made of control and TM strands, with an l/h of 4.4 and 5.0 respectively, was well predicted with the SAM/TBT model. Still, an error of 15.4% was seen with one of the two CLSVL control beams tested; this could be reduced by improving the confidence on the estimate of the out-of-plane shear modulus of the laminates, referred in FIG. 25b. On the other hand, the SAM/BBT model poorly predicted the bending stiffness of the beams with l/h<5 made of control and TM strands. This indicates that the bending modulus of elasticity, MOE, fades in importance and the shear modulus, G₁₃ and G_{23,} starts to play a bigger role.

FIGS. 39a-b show results from four-point bending. The mid-span deflection of the CLSVL beam made using the control strands, with a span-to-depth ratio of 20.8, was accurately predicted. A model which considers the shear deflection “BBT/SAM” and a model that considers shear deflections “TBT/SAM” were able to mimic deflection quite well (FIG. 39a). The results suggest that for span-to-depth ratios greater than 20, the shear deflections in the TM CLSVL panels can be neglected.

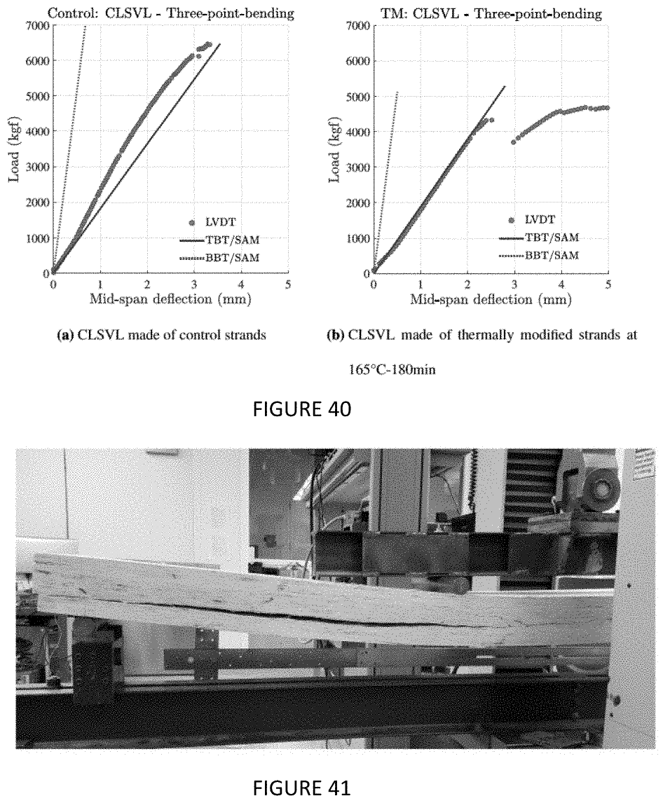

FIGS. 40a-b show results from three-point bending. FIGS. 40a-b show the load versus mid-span deflection of the three-point bending test performed with a small span-to-depth ratio (<5). The deflection of the CLSVL beam made of control strands, with span-to-depth ratio equal to 4.3 (FIG. 40a), was accurately predicted near the peak load with a model account for shear deflection “TBT/SAM.” With the model that does not account for shear deflection, “BBT/SAM,” there is an underestimation of the deflection. This indicates that the modulus of elasticity, E, fades in importance, as shear deflections start to play a major role. A similar response occurs with the CLSVL beam made of thermally modified strands (FIG. 40b) with a span-to-depth ratio of 5.

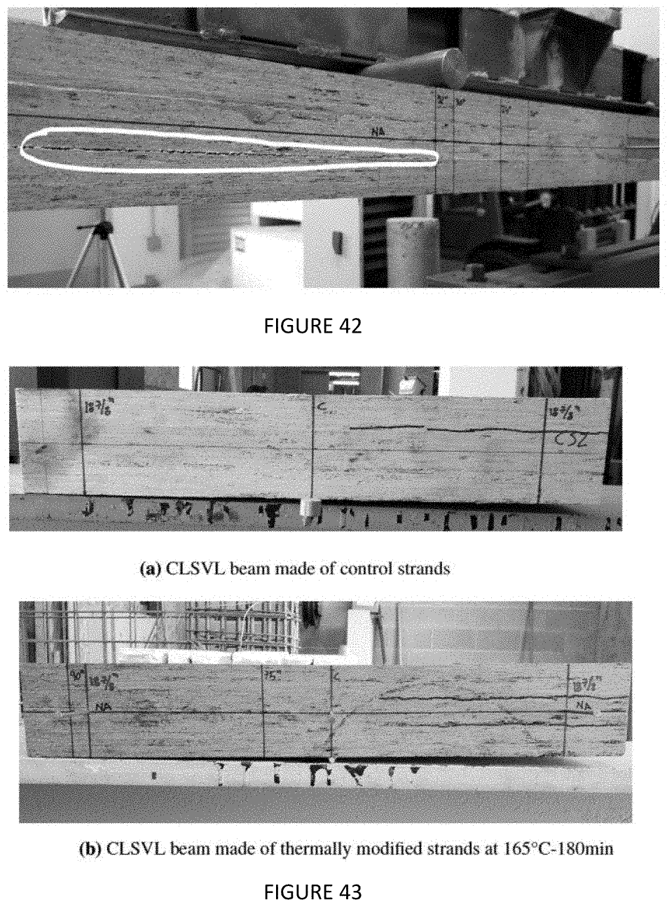

Furthermore, the failing mechanism for each beam was visually assessed; finding that in all cases a shear failure occurred (FIGS. 41, 42 and 43a-b). The loading caused the wood fibers near the core laminates (transversal laminates) to fail and extend mostly horizontally to or from the loading point to the reaction. The maximum value at which the beam failed was measured and used to estimate the shear limit state, shown in the last column of Table 4. For instance, the CLSVL beam made of TM strands under four-point bending had a premature failure at the PUR glue line. The manual application of the PUR resin with a roller could have caused a non-uniform application of the adhesive, leaving some parts with limited resin. Moreover, since this premature failure did not occur in the other CLSVL beams, not to be bound by theory, it is thought that the TM is not affecting the bonding performance with PUR. Now, without consideration of this specimen, no major difference is observed in the estimated maximum shear stress values between the control and the TM composite panels.

Unlike traditional lumber-based cross-laminated timber (CLT) mass timber products that experience a rolling shear failure mechanism, this does not appear to occur with strand-based products, as reported elsewhere [61, 57, 62]. For instance the CLSVL beams from this work did not experience a rolling shear type failure. Despite this, the shear capacity of the CLSVL beams did not appear to be substantially higher than traditional CLT, with strength capacity ranging between 1 to 3 MPa [63, 62]. However, due to the limited sample size, more testing is required to accurately assess the strength capacity.

### Exemplary Conclusions

Consistent vertical density profile (VDP) is a large value proposition for this technology. The processes described herein enable, for example, one to convert SDT into many strand-based composite products that can be substitutes for different lumber-based and peeled veneer-based products.

TM intensity, in terms of dwell time and temperature, has no significant effect on tensile modulus of elasticity; however, temperature plays a significant role on tensile strength, with higher temperatures leading to lower strength. The water wettability and hygroscopicity of the TM wood-strands was reduced, while SFE was found to increase, possibly helping the wetting of pMDI resin used for the manufacture of wood-strand composites. Moreover, a slight increase in the degree of crystallinity was observed as TM temperature increases, but an indication of subsequent drop exists as treatment conditions become more intense. This change in relative degree of crystallinity may favor tensile modulus of elasticity to remain unaffected, or even to slightly increase. The crystallinity increase may also impart moisture resistance, since its structure may result in reduced accessibility of water molecules to OH-groups.

Similar to the wood-strands, TM does not have a significant effect on bending modulus of elasticity of panels, although a slight increase may exist. On the other hand, modulus of rupture of the panels was negatively affected by TM, mostly influenced by the temperature during treatment, and to a much less extent the dwell time. The internal bond strength was reduced with TM. Moreover, TM significantly reduces the thickness swell of the composite panels when soaked in water. An indirect measurement of dimensional stability, TS/WA ratio, was found to significantly decrease with TM, indicating the resulting product to be more dimensionally stable in moisture rich environments. The decrease of this ratio suggests that the bond water capacity is reduced with TM, and that the water is now found as free water in the voids of the wood fibers. Lastly, TM improved decay resistance to brown rot fungi for both wood-strands and wood-strand composite panels, which was found to have a strong correlation with the sorption reduction. These factors may be attributed to the depolymerization of hemicelluloses which are hydrophilic in nature and also serve as an alimentary source to fungi. Despite the unintended strength reduction with TM, the mechanical performance of the TM woods-strand composite panels is similar to or better than other wood-based materials used in structural applications. Further studies in densification of the panels could result in improved performance TM, for instance, could reduce the counterproductive springback effect after hot-pressing.

The Shear Analogy Method in conjunction with a Timoshenko Beam Element in a finite element implementation was found to be an appropriate way to model the out-of-plane bending behavior of CLSVL, even for the case of TM wood-strands. The model accurately predicted the bending stiffness of the tested beams under different span-to-depth ratios and loading conditions (three- and four-point bending). Furthermore, TM did not seem to have an impact on the shear capacity of CLSVL beams under bending. The shear failure mechanism of the CLSVL was observed to be different from traditional rolling shear failure for CLT. Nevertheless, the shear capacity of the CLSVL beams was not necessarily higher.

From the comprehensive study conducted it was found that the CLSVL made of TM wood-strands can be effectively modeled, proving to be predictable as required for structural elements. Furthermore, the implementation of the discussed TM process likely increases the prospective service life of the material by reducing the moisture intake, and improving decay resistance and dimensional stability.

### REFERENCES

1. M. R. Pelaez-Samaniego, V. Yadama, E. Lowell, R. Espinoza-Herrera, A review of wood thermal pretreatments to improve wood composite properties, Wood Science and Technology 47 (6) (2013) 1285-1319
2. M. J. Boonstra, J. Van Acker, B. F. Tjeerdsma, E. V. Kegel, Strength properties of thermally modified softwoods and its relation to polymeric structural wood constituents, Annals of Forest Science 64 (7) (2007) 679-690.
3. Y. Zheng, Z. Pan, R. Zhang, B. M. Jenkins, S. Blunk, Properties of medium-density particleboard from saline Athel wood, Industrial Crops and Products 23 (3) (2006) 318-326.
4. M. N. Angle\grave{ }s, F. Ferrando, X. Farriol, J. Salvadó, Suitability of steam exploded residual softwood for the production of binderless panels. Effect of the pre-treatment severity and lignin addition, Biomass and Bioenergy 21 (3) (2001) 211-224.
5. W. E. Hsu, W. Schwald, J. Schwald, J. A. Shields, Chemical and physical changes required for producing dimensionally stable wood-based composites, Wood Science and Technology 22 (3) (1988) 281-289.
6. B. M. Esteves, H. M. Pereira, Wood modification by heat treatment: A review, Bioresources 4 (1965) (2009) 370-404.
7. K. Candelier, M. F. Thevenon, A. Petrissans, S. Dumarcay, P. Gerardin, M. Petrissans, Control of wood thermal treatment and its effects on decay resistance: a review, Annals of Forest Science 73 (3) (2016) 571-583.

### 8. F. SHAFIZADEH, P. P. S. CHIN, Thermal Deterioration of Wood, 1977, pp. 57-81.

9. W. E. Hillis, High temperature and chemical effects on wood stability—Part 1: General considerations, Wood Science and Technology 18 (4) (1984) 281-293.
10O. Hosseinaei, S. Wang, A. A. Enayati, T. G. Rials, Effects of hemicellulose extraction on properties of wood flour and wood-plastic composites, Composites Part A: Applied Science and Manufacturing 43 (4)(2012) 686-694.

### 11. C. A. Hill, Wood Modification: Chemical, Thermal and Other Processes, 2006.

12. P. MITCHELL, Irreversible property changes of small loblolly pine specimens heated in air, nitrogen, or oxygen, Wood and fiber science 20 (3) (1988) 320-335.
13. V. Caprai, F. Gauvin, K. Schollbach, H. J. Brouwers, Influence of the spruce strands hygroscopic behaviour on the performances of wood-cement composites, Construction and Building Materials 166 (2018) 522-530.
14O. F. H. t. Mongolian, P. Wood, Influence of Steam Pressure on Chemical Changes of Heat-Treated Mongolian Pine Wood, BioResources 6 (2) (2011) 1880-1889.
15. M. Hakkou, M. Pe\acute{ }trissans, P. Ge\acute{ }rardin, A. Zoulalian, Investigations of the reasons for fungal durability of heat-treated beech wood, Polymer Degradation and Stability 91 (2) (2006) 393-397.
16. O Unsal, S. N. Kartal, Z. Candan, R. A. Arango, C. A. Clausen, F. Green, Decay and termite resistance, water absorption and swelling of thermally compressed wood panels, International Biodeterioration and Biodegradation 63 (5) (2009) 548-552.

### 17. N. Kohan, B. K. Via, S. Taylor, A Comparison of Geometry Effect on Tensile Testing of Wood Strands, Forest Products Journal 62 (3) (2013) 167-170.

18. G. Y. Jeong, D. P. Hindman, D. Finkenbinder, J. N. Lee, Z. Y. Lin, Effect of loading rate and thickness on the tensile properties of wood strands, Forest Products Journal 58 (10) (2008) 33-37.
19. M. De Meijer, S. Haemers, W. Cobben, H. Militz, Surface energy determinations of wood: Comparison of methods and wood species, Langmuir 16 (24) (2000) 9352-9359.

### 20. S. Shi, D. Gardner, Dynamic Adhesive Wettability of Wood, Wood and Fiber Science 33 (1) (2001) 58-68.

21. J. Follrich, U. Mu\ddot{ }ller, W. Gindl, Effects of thermal modification on the adhesion between spruce wood (Picea abies Karst.) and a thermoplastic polymer, Holz als Roh und Werkstoff 64(5) (2006) 373-376.
22. X. Wang, F. Wang, Z. Yu, Y. Zhang, C. Qi, L. Du, Surface free energy and dynamic wettability of wood simultaneously treated with acidic dye and flame retardant, Journal of Wood Science 63 (3) (2017) 271-280.
23. A. C. Ziglio, M. R. Sardela, D. Gonc ̧alves, Wettability, surface free energy and cellulose crystallinity for pine wood (Pinus sp.) modified with chili pepper extracts as natural preservatives, Cellulose 25 (10) (2018) 6151-6160.

### 24. F. M. Fowkes, ATTRACTIVE FORCES AT INTERFACES, Industrial & Engineering Chemistry (1964).

25. F. M. Fowkes, Calculation of work of adhesion by pair potential summation, Journal of Colloid And Interface Science (1968).
26. F. M. Fowkes, Donor-acceptor interactions at interfaces, The Journal of Adhesion (1972).
27. T. Young, An essay on cohesion of fluids, Philosophical Transactions of the Royal Society of London 95 (1805) 65-87.
28. X. Huang, D. Kocaefe, Y. Boluk, Y. Kocaefe, A. Pichette, Effect of surface preparation on the wettability of heat-treated jack pine wood surface by different liquids, European Journal of Wood and Wood Products 70 (5) (2012) 711-717.
29. Z. Qin, Q. Gao, S. Zhang, J. Li, Surface free energy and dynamic wettability of differently machined poplar woods, BioResources 9 (2) (2014) 3088-3103.
30. Z. m. Liu, F. h. Wang, X. m. Wang, Surface Structure and Dynamic Adhesive 36 (2) (2004) 239-249.

### 31. H. P. Gavin, The Levenburg-Marqurdt Algorithm For Nonlinear Least Squares Curve-Fitting Problems (2019) 1-19.

32. J. Blahovec, S. Yanniotis, Gab generalized equation for sorption phenomena, Food and Bioprocess Technology 1 (1) (2008) 82-90.
33. I. D. Hartley, Application of the Guggenheim-Anderson-deBoer sorption isotherm model to Klinki pine (Araucaria klinkii Lauterb.), Holzforschung (2000)
34. I. D. Hartley, S. Wang, Y. Zhang, Water vapor sorption isotherm modeling of commercial oriented strand panel based on species groups and resin type, Building and Environment 42 (10) (2007) 3655-3659.
35. A. Derkowski, R. Mirski, J. Majka, Determination of sorption isotherms of Scots pine (Pinus sylvestris L.) wood strands loaded with Melamine-Urea-Phenol-Formaldehyde (MUPF) resin, Wood Research 60 (2) (2015) 201-210.

### 36. L. Segal, J. J. Creely, A. E. Martin, C. M. Conrad, An Empirical Method for Estimating the Degree of Crystallinity of Native Cellulose Using the X-Ray Diffractometer, Textile Research Journal 29 (10) (1959) 786-794.

37. E. Karacabeyli, D. Brad, Hand book cross laminated timber, 2013.
38. J. Zhou, Y. H. Chui, M. Gong, L. Hu, Elastic properties of full-size mass timber panels: Characterization using modal testing and comparison with model predictions, Composites Part B: Engineering 112 (2017) 203-212.
39 . M. Eisenberger, Derivation of shape functions for an exact 4-D.O.F. Timoshenko beam element, Communications in Numerical Methods in Engineering 10 (9) (1994) 673-681.
40. F. W. Calonego, E. T. Severo, A. W. Ballarin, Physical and mechanical properties of thermally modified wood from E. grandis, European Journal of Wood and Wood Products 70 (4) (2012) 453-460.
41. W. Paul, M. Ohlmeyer, H. Leithoff, M. J. Boonstra, A. Pizzi, Optimising the properties of OSB by a one-step heat pre-treatment process, Holz als Roh und Werkstoff 64 (3) (2006) 227-234.

### 42. D. Sandberg, A. Kutnar, THERMALLY MODIFIED TIMBER : RECENT DEVELOPMENTS IN EUROPE AND NORTH AMERICA Dick Sandberg, Wood and Fiber Science 48 (2015) 28-39.

43. M. T. R. Bhuiyan, N. Hirai, N. Sobue, Changes of crystallinity in wood cellulose by heat treatment under dried and moist conditions, Journal of Wood Science 46 (6) (2000) 431-436.
44. A. Kutnar, B. Kric ̆ej, M. Pavlic ̆, M. Petric ̆, Influence of treatment temperature on wettability of Norway spruce thermally modified in vacuum, Journal of Adhesion Science and Technology 27 (9) (2013) 963-972.
45. C. Croitoru, C. Spirchez, A. Lunguleasa, D. Cristea, I. C. Roata, M. A. Pop, T. Bedo, E. M. Stanciu, A. Pascu, Surface properties of thermally treated composite wood panels, Applied Surface Science 438 (2018) 114-126.
46. M. Altgen, W. Willems, H. Militz, Wood degradation affected by process conditions during thermal modification of European beech in a high-pressure reactor system, European Journal of Wood and Wood Products 74 (5) (2016) 653-662.
47. H. Wikberg, S. L. Maunu, Characterisation of thermally modified hard And softwoods by 13C CPMAS NMR, Carbohydrate Polymers (2004).
48. M. T. R. Bhuiyan, N. Hirai, Study of crystalline behavior of heat-treated wood cellulose during treatments in water, Journal of Wood Science 51 (1) (2005) 42-47.
49. M. J. Boonstra, B. Tjeerdsma, Chemical analysis of heat treated softwoods, Holz als Roh und Werkstoff 64 (3) (2006) 204-211.
50. K. Laine, K. Segerholm, M. Wa ̊linder, L. Rautkari, M. Hughes, Wood densification and thermal modification: hardness, set-recovery and micromorphology, Wood Science and Technology 50 (5) (2016) 883-894.
51. G. He, N. Yan, Effect of moisture content on curing kinetics of pMDI resin and wood mixtures, International Journal of Adhesion and Adhesives 25 (5) (2005) 450-455.
52. P. Solt, S. Libowitzky, H. W. van Herwijnen, J. Konnerth, Improved method for analyzing cohesive strength development of pMDI, Wood Science and Technology 54 (1) (2020) 7-17.
53. S. W. Weight, V. Yadama, Manufacture of laminated strand veneer (LSV) composite. Part 1: Optimization and characterization of thin strand veneers, Holzforschung 62 (6) (2008) 718-724.
54. R. J. Ross, F. P. L. USDA Forest Service., Wood handbook: wood as an engineering material (2010).
55. D. Kretschmann, F. P. L. (Us), Effect of various proportions of juvenile wood on laminated veneer lumber, Russell The Journal Of The Bertrand Russell Archives 521 (1993).
56. R. Hernandez, D. W. Green, D. E. Kretschmann, S. P. Verrill, Improved utilization of small-diameter ponderosa pine in glulam timber, US Forest Service (2005) 20.
57. Z. Wang, M. Gong, Y. H. Chui, Mechanical properties of laminated strand lumber and hybrid cross-laminated timber, Construction and Building Materials 101 (November 2017) (2015) 622-627.
58. Z. Wang, J. Zhou, M. Gong, Y. H. Chui, X. Lu, Evaluation of modulus of elasticity of laminated strand lumber by non-destructive evaluation technique, BioResources 11 (1) (2016) 626-633.

### 59. S. Wang, S. Wang, Layer Thickness Swell and Related Properties of Commercial OSB Products: A Comparative Study (2003) 65-76.

### 60. R. Erikson, Gorman, Solid Wood Products Mechanical Grading of Lumber Sawn From Small-Diameter Lodgepole Pine , Trees From Northern I Daho 50 (8909) (2000) 59-65.

61. J. Niederwestberg, J. Zhou, Y. H. Chui, Mechanical properties of innovative, multi-layer composite laminated panels, Buildings 8 (10) (2018) 1-13.
62. W. G. Davids, N. Willey, R. Lopez-Anido, S. Shaler, D. Gardner, R. Edgar, M. Tajvidi, Structural performance of hybrid SPFs-LSL cross-laminated timber panel Construction and Building Materials 149 (2017) 156-163.
63. Q. Zhou, M. Gong, Y. H. Chui, M. Mohammad, Measurement of rolling shear modulus and strength of crosslaminated timber fabricated with black spruce, Construction and Building Materials 64 (2014) 379-386.

We claim:

1. A composite wood-strand material, comprising:
a plurality of wood veneers having a thickness of 0.125 to 0.250 inches thick which are formed from a plurality of the thermally modified wood strands and first adhesive,
wherein the plurality of wood-strand veneers each have a density of 15 to 50 pounds per cubic foot,
wherein the plurality of wood-strand veneers each have at least some thermally modified wood strands stacked on top of one another in at least a partially overlapping fashion,
wherein the plurality of wood-strand veneers are joined together by a second adhesive in the form of a composite wood-strand material having a thickness of ⅜-inch to 24 inches, wherein the first adhesive and second adhesive are the same or different

2. The composite wood-strand material of claim 1 wherein the thermally modified wood strands are comprised of at least one or more softwoods.

3. The composite wood-strand material of claim 2 wherein the at least one or more softwoods are selected from the group consisting of pine, spruce, and cedar.

4. The composite wood-strand material of claim 1 wherein the thermally modified wood strands are comprised of at least one or more hardwoods.

5. The composite wood-strand material of claim 4 wherein the one or more hardwoods are selected from the group consisting of aspen, birch, balsa, and maple.

6. A method of producing composite wood-strand materials, comprising:
thermally modifying a plurality of wood strands of 3 to 8 inches long, 0.25 to 2.5 inches wide, and 0.012 to 0.020 inches thick;
forming veneers having a thickness of 0.125 to 0.250 inches thick from a plurality of the thermally modified wood strands and adhesive under temperature and pressure conditions which yield wood veneers having a density of 15 to 50 pounds per cubic foot, wherein the wood veneers have at least some thermally modified wood strands stacked on top of one another in at least a partially overlapping fashion; and
forming a composite wood strand material of a selected thickness from a plurality of the veneers and adhesive material.

7. The method of claim 6 wherein the wood strands are from softwood.

8. The method of claim 7 wherein the softwood is pine.

9. The method of claim 7 wherein the softwood is from timber having a diameter of 4 to 12 inches.

10. The method of claim 6 wherein a pressure is applied to the thermally modified wood strands during formation of the veneers ranges from 4.5 to 12 bar.

11. The method of claim 10 wherein the pressure ranges from 7-9 bar.

12. The method of claim 6 wherein the composite wood strand material has a thickness ranging from ⅜ inch thick to 24 inches thick.

13. The method of claim 6 wherein heating of the plurality of wood strains is performed under pressure of 0 to 12 bar.

14. The method of claim 13 wherein the pressure ranges from 4.5 to 12 bar.

15. The method of claim 6 wherein composite would strand material is formed under a pressure ranging from 4.5 to 12 bar.

16. The method of claim 6 wherein the heating of the plurality of wood strands is performed at a temperature ranging from 150° to 240° C.

17. The method of claim 16 wherein the temperature ranges from 165° C. to 175° C.

18. The method of claim 16 wherein the heating is performed for 0.5 to 2.5 hrs.

19. The method of claim 6 wherein the heating of the wood strands is performed such that the thermally modified wood strands have a crystallinity that is greater than the crystallinity of wood strands that that have not been heat treated.

20. The method of claim 6 wherein the heating of the wood strands is performed such that a strength of the thermally modified would strands is at least 70% of a strength of the woods strands that have not been heat treated.

21. The method of claim 6 wherein the length of the wood strands ranges from four to six inches.
